(19) United States
(12) Patent Application Publication
(10) Pub. No.: US 2019/0172130 A1
(43) Pub. Date: Jun. 6, 2019

(54) Community Value Creating Local Digital Currency System

(71) Applicant: Michael H Gurin, Glenview, IL (US)

(72) Inventor: Michael H Gurin, Glenview, IL (US)

(21) Appl. No.: 15/829,985

(22) Filed: Dec. 4, 2017

(51) Int. Cl. G06Q 40/04; G06Q 30/02; G06Q 40/06

(52) U.S. Cl. CPC G06Q 40/04; G06Q 30/0283; G06Q 50/30; G06Q 2220/12; G06Q 40/06

(57) ABSTRACT

A system and method for price adjustment as a function of time through control and comprehensive parametric calculation of business transactions and/or task execution, particularly by issuing local currency, based on a projected velocity of money within the community in which the transaction is taking place. Additionally, the system executes the transaction by controlling and incentivizing as a function of time and local impact score through local currency adjustment to maximize community gain including maximizing demand for local products.

### FIELD OF INVENTION

The present invention relates to a transaction system to maximize community value creation by providing a real-time pricing adjustment method based on either the resulting velocity of money within host community of a local transaction or avoidance of an adverse non-local transaction to account for both direct primary and indirect secondary impact on the community.

### BACKGROUND OF INVENTION

Prior art of purchasing transaction focuses on discounting directly to a specific consumer using standard coupon methods, with the majority having a discount pre-determined (though occasionally in real-time) independent of any secondary factors associated with maximizing or accounting for value creation within the community that the purchase transaction takes place.

Another embodiment of a prior art utilizes velocity of money solely for calculating money flow into and out of a single customer banking account. This embodiment is void of money circulation within a community and completely void of making a distinction of cash flow within a specific community.

A need for a dynamic pricing application may be used to account for wealth creation involved in providing and maintaining product infrastructure, including the cost for logistics, sales personnel and manufacturing. Measuring resource utilization and calculating the corresponding velocity of money impact enables a sustainable community to achieve optimal wealth creation within the community, and therefore a dynamic pricing that drives optimal wealth creation within the community including and particularly discounting total price through the addition of local currency rebates or leveraging a real-time impact/contribution driven currency conversion from a broader region currency (hereinafter referred to as “regional currency”) to a highly localized local currency (hereinafter referred to as YoCal currency). Such a system overcomes otherwise less expensive pricing based on pricing solely in non-community based regional currency.

### SUMMARY OF INVENTION

The present invention is a purchasing transaction system used to account for currency velocity of money within a sustainable community infrastructure, including the comprehensive cost for logistic and sales and the comprehensive gains of maintaining/maximizing currency residency within the community, minimizing currency outflows and preferably maximizing currency inflows.

A further object of the invention is to actualize the comprehensive and secondary gains of local velocity of money within a community including gains in real estate value, reductions of environmental impact, and maximize local labor contribution (and therefore minimize government economic subsidies or offsets, particularly when universal income or basic income or negative income economic policies are in place, which are not factored in traditional non-velocity of money pricing models).

A yet further object of the invention is to establish a fundamental currency valuation built on true value creation rather than speculation (e.g., Bitcoin or other blockchain-based cryptocurrency), notably a currency that has true value in the economy in which the currency predominantly circulates.

Another object of the invention is to optimize system value creation and capital efficiency within the commerce network, especially for networks that either fundamentally comprehend every transaction has an impact greater than the individual decision of the purchaser on the overarching ecosystem in which additional consumers, businesses, or residences within the community/network of interest maximize community gain and align community interests.

Yet another object of the invention is to maximize return on investment within the community, such that risk is rewarded preferentially for community gains or with entities (e.g., businesses including financial services banks, coops, etc.) that have fundamental alignment with the host current community.

All of the aforementioned features of the invention fundamentally recognize that significant leverage is achieved by maximizing local impact, as each transaction achieves such leverage due in large part to the community velocity of money.

### BRIEF DESCRIPTION OF DRAWINGS

FIG. 1 is a diagram of the object inter-relationships of data structure.

FIG. 2 is a data structure diving deeper into employee actions relative to the community in which he/she lives in.

FIG. 3 is a process flow depicting money inflow(s) and outflow(s) from a community centric perspective.

FIG. 4 is a detailed object structure for the item transaction.

FIG. 5 is an object data structure depicting both a local and regional currency.

FIG. 6 is an object relationship diagram that is employee centric.

FIG. 7 is an object data diagram that is asset centric.

FIG. 8 is an object diagram that is transportation vehicle centric

FIG. 9 is an object data diagram that is energy centric.

FIG. 10 is an object data diagram and pricing mechanism for benefits realized by the host community.

FIG. 11 depicts local transaction impact through a financial service company.

FIG. 12 depicts client and business objects physically located within a host current community.

FIG. 13 depicts assets within a shared resource pool.

FIG. 14 depicts the data structure supporting the local currency mining.

FIG. 15 depicts the data structure around a business within the host community.

FIG. 16 depicts the hardware implementation of the system.

FIG. 17 is the data structure centric to the Local Currency Mining Engine.

FIG. 18 depicts the data structure for a rating scale for all parties of the transaction.

FIG. 19 depicts data structure as calculated, communicated, and then presented to client to show regional and local pricing.

FIG. 20 depicts operational control of the local currency mining engine as a specific application program on the server.

FIG. 21 depicts operational control of the shared resource engine as a specific application program on the server.

FIG. 22 is the system operating program for the velocity engine specific to a unique client.

FIG. 23 is the process diagram centered around the community impact engine from a client centric perspective.

FIG. 24 is the process diagram centered around the community impact engine from a business centric perspective.

FIG. 25 is a graph of a local currency discount as a function of time.

### DEFINITIONS

The term “velocity of money” refers to the rate at which money is exchanged from one transaction to another and how much a unit of currency is used in a given period of time. Velocity of money is usually measured as a ratio of GNP to a country's total supply of money.

The term “regional currency” refers to a currency that is accepted in the broader region in which a reference local community is within. In most cases the regional currency is the monetary currency of the host country (e.g., a local community of Glenview is within the state of Illinois that is further within the country of the United States that uses the United States dollar, or a local community of Munich is within the state of Bavaria that is further within the country of Germany that is further within the economic alliance of Euro Member Countries that uses the Euro).

The term “YoCal” refers to a local currency that is created to fundamentally drive local transactions for a reference host local community. It is understood that multiple local currencies can co-exist including co-existence with the broadest currency (i.e., typically the regional currency such that the regional currency is the country currency). Each local currency, a term such that local is in direct relationship to a geofence defined physical area, begins with the smallest geographic territory/land (e.g., neighborhood) and subsequent larger geographic territory/land (e.g., special economic zone, or city) in which the host local community resides through yet larger geographic territory/land (e.g., state) and ultimately country (though typically the currency conversion is already embedded in the regional currency) that is independent of velocity of money. At the very least YoCal currency should be of the largest region responsible for normalizing income of the consumer/resident to the universal income standard. At the best, YoCal currency should be for the smallest region practical such that a commitment to reinvest (at least a portion of profits) into this region (i.e., city or even neighborhood) provides alignment of risk pools (particularly for financial transactions such as insurance, mortgages, credit cards, etc.). A mortgage delinquency within a neighborhood has an adverse financial impact beyond just the adverse impact on the financial service company providing the mortgage asset/liability. Further in this era of ultra-low savings account interest rates, it is best for community value creation such that local savings accounts are matched/coupled with local mortgages and that the financial transaction business has a commitment such that returns (i.e., profits) beyond what is necessary to maintain an adequately funded risk pool is reinvested into capital assets that provide direct benefit to the community at large and potentially even more narrowly focused to the providers of the capital (i.e., local savings accounts). An optimal scenario is such that the profits are divided amongst the host community, guarantor savings account(s) provided as the capital basis, and shareholders of the financial service organization (which could in fact be the host community itself e.g., a coop).

### DETAILED DESCRIPTION OF INVENTION

Here, as well as elsewhere in the specification and claims, individual numerical values and/or individual range limits can be combined to form non-disclosed ranges.

Exemplary embodiments of the present invention are provided, which reference the contained figures. Such embodiments are merely exemplary in nature. Regarding the figures, like reference numerals refer to like parts.

YoCal local currency accounts for local content (differentiates between service, manufacturing, assembly, distribution, etc.), velocity of money impact on the local community. None of this is in prior art at all.

The fundamental invention is to utilize a YoCal currency (either entirely) or in conjunction with a regional currency such that price differential between locally produced product more fully accounts for secondary community gains realized by the highly leveraged gains achieved by velocity of money gains with the host community. The velocity of money gains are realized, though at further reducing levels as the geographic region increases in size for each transaction, at multiple expanding communities (i.e., neighborhood, city, state, country).

The fundamental goal of the invention is to normalize local costs (which when not accounting for the real gains achieved within the community) and yet not included to influence local decisions that are positively impactful on the host local community (and thus increase value of home) property in the long-term, at the very least; or enables additional community services that are impacted by this local support. The fundamental goal is such that, where quantified community value is created by supporting local businesses (all things equal that have a greater local velocity of money impact) the cost at time of acquisition enables true comparison to non-local content that has much lower secondary community impact. Lastly, the need to create a banking ecosystem that enables conversion of local currency (also referred to as a crypto-currency or blockchain currency) into regional (or country) currency when needed as directly pegged to velocity of money gains (based on either projected or historic realizations for each consumer, business, etc.). One such example is to create a bank that offers a much higher interest rate by providing local currency (i.e., local content dollars) in return beyond a traditional interest rate in a regional currency (i.e., no local content dollars or linkage). The issuance of YoCal local currency is to correlate the issuance to the community impact value such that an increase takes place at least one day beyond the transaction day (in other words, it is understood and anticipated that the benefit from the YoCal local currency is not assumed or even desired to result in immediate benefit or access).

Another fundamental challenge that the invention overcomes is how to create an ecosystem (including a restaurant) where the cost of goods is very small relative to the total price to consumers, so as to create larger incentive for actual ingredients (otherwise referred to as raw material) content. One such mechanism anticipated by the invention is to utilize an exponentially increasing gain in YoCal currency benefits to the consumer for increasing local content. The inclusion of business profits being realized and importantly where those business profits are first distributed (to shareholders, owners, etc.) and then ultimately reinvested in an important local impact factor in determining YoCal currency benefits. Product distribution, including logistics is another important element in creating community value. For items such as food primary benefits are realized as freshness is directly correlated with nutrient quantity and quality. Normalizing total real cost (i.e., YoCal adjusted pricing) to nutrient levels rather than absolute mass of food product (e.g., fresh produce, that is optimized when grown locally and harvest virtually in real-time relative to consumption). A sustained local campaign has the benefit of further increasing the velocity of money over time, as locally sourced products has a fundamental benefit of clearly skipping the middleman (as the more intermediaries that exist will immediately translate into products that are less fresh and therefore less nutrient-rich).

Local content delivery is greatly enabled, such as local logistics services that connect local businesses. Important factors include:

Location of Business Profits

Location of Employee. Spend, including community shared resources, distance to travel home (and whether or not shared vehicles or public transportation is used)

Location of Transportation Assets (e.g., shared vehicles) including where profits are spent from logistics, also where shared vehicles are stored

Use Cases: 1) Bioenergy vs. Solar/Wind; 2) Shared Resources—1) made here and asset owned here, 2) not made here, but asset is owned and used here, 3) not made here, not owned here, but used here; 3)

Capital “Capex” vs. Operating “Opex” Lifetime Ratio: Local vs. External. ROI period until gains become local

Category of Goods: Some goods yield significant leverage into the host local community via additional productivity gains (e.g., shared cars/vehicles enable employees to get to jobs vs. shared took used for a personal basis has no further community leverage.).

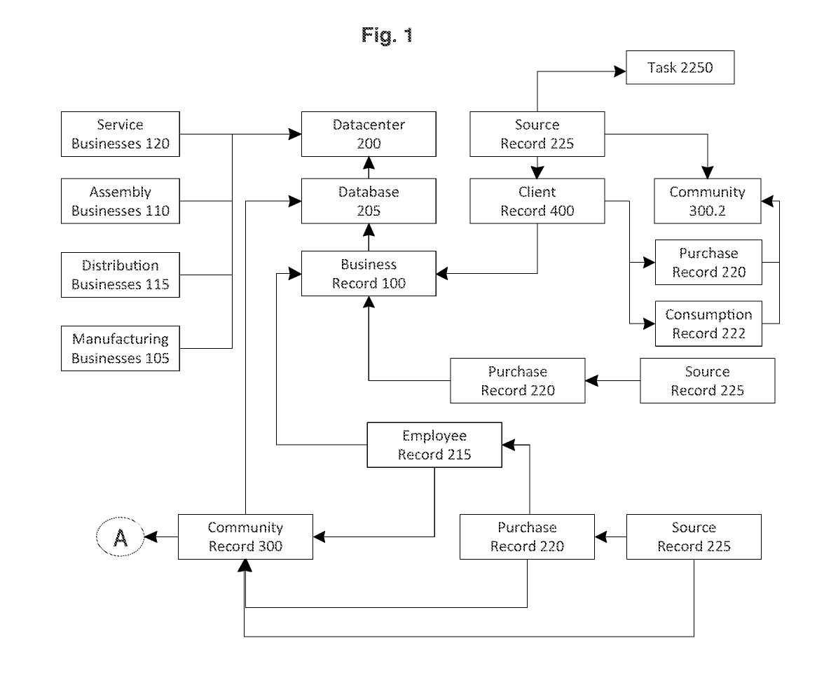

Turning to FIG. 1, FIG. 1 is a diagram of the object inter-relationships of data structure. Though shown as being within a single datacenter 200, it is understood that the singular representation of the datacenter 200 (data center and datacenter are used interchangeably) can be distributed (rather than a centralized) datacenter or universally on a “cloud”. The database 205, also shown as a singular entity can also be a distributed/decentralized database comprised of integrated (yet distributed) set of data records. It is a fundamental object of the invention to draw a distinction between service businesses 120, distribution businesses 115, assembly businesses 110, and manufacturing businesses 105 as the value creation within a host community having a community (data) record 300 ranges from respectively the lowest to highest level. However, it is often such that service businesses 120 have a disproportionate margin (whether absolute in terms of currency or percentage) such as supermarkets (prior to all the other locally incurred costs that make supermarkets a low-margin business). Another service business category includes food service such as restaurants and coffee houses, where the act of providing the food product is relatively labor intensive and most often the employee 215 providing such service is local within the host community 300. Each community 300 has a database that contains local businesses 100, clients 400 (which can be local or not) of that local business 100 in which clients 400 (though not typical in the current retail environment, but anticipated in future ecosystem embodiments) are linked to source record(s) 225 as the client 400 may provide a service task 2250 or a raw material requiring further processing (e.g., raised chicken to be butchered/processed) or assistance of gathering products from a retail shelf for another client. It is anticipated that a wide range of tasks can be conducted by the client include shopping (for others), cooking, laundry, education, healthcare, driving, growing, harvesting though the most relevant for a retail type of business would be shopping for others (concurrent with their own in-aisle shopping). The client is linked to a host community 300.2 in this instance through the source record 225 where the product is manufactured/grown therefore the local impact accounts for this value creation. The inventive ecosystem further accounts for relative ranking of each client to the degree in which purchase(s) (i.e., transactions) 220 are made locally as well consumption 222 made locally. The invention makes a distinction for purchase 220 location and consumption 222 location, such as a client can live in Glenview, Ill. and yet be vacationing in San Juan, Puerto Rico where such a purchase is optimal on a global basis in addition to being optimal for the community in which the client 400 is presently located within. A business 100 in which a client 400 elects to conduct a business transaction is all things equal best located closest to where the client anticipates consumption of the products purchased, but also such that the business 100 stocks products that purchased 220 from a source 225 that is preferably also located local to the business location. Each business 100 has employees 215 that live within a community 300, with a truly committed local business 100 also making commitments to hire employees 215 that live in close proximity to the business and certainly within the same local community 300. And a local committed employee also elects to maximize their purchases 220 from sources 225 that are also local to the same local community 300. The invention includes business local parameters/factors in the local impact parameter that is inclusive of the velocity of money within the same local community 300.

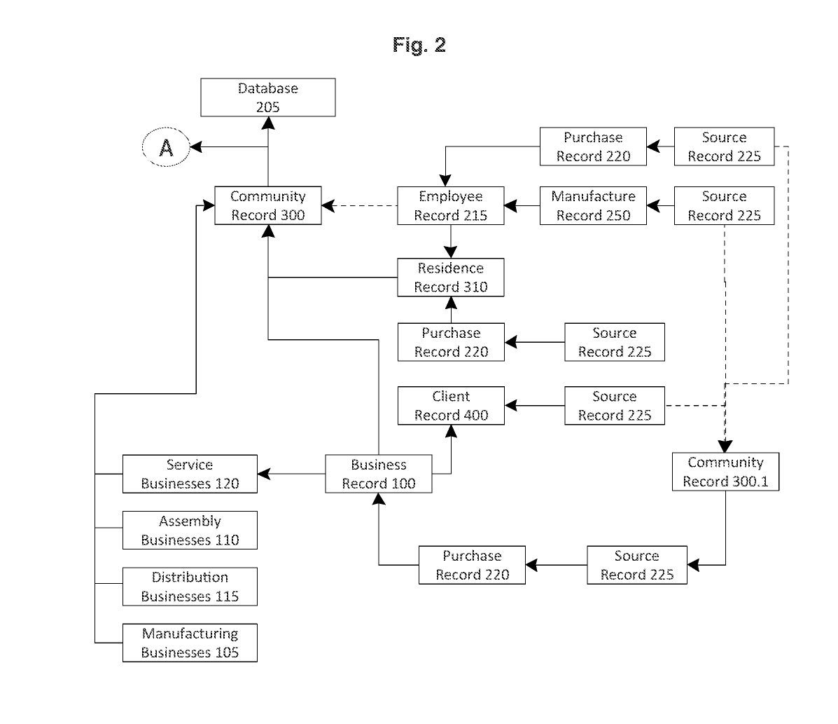

Turning to FIG. 2, FIG. 2 is another data structure diving deeper into employee 215 actions relative to the community 300 in which he/she lives in. The employee 215 makes purchase 220 decisions from product sourced 225 from a community 300.1 (in this instance depicting a product sourced outside of the community in which the employee lives). It is optimal for an employee to work and live in the same community, however in the event that isn't possible it is best for employees to purchase product within a community in which consumption takes place (e.g., purchasing lunch during a work break is best done within a community 300.1 where the business 100 is located rather than where the employee lives). The employee 215 has a residence record 310 that maintains database records containing purchases 220 and their respective source 225 record for purchases intended to be consumed within the residence. Those purchases are best done such that the source 225 community is identical to the residence 310 within its community 300. The business 100 is linked to the category of business it falls within, which is indicative in this example as service businesses 120.

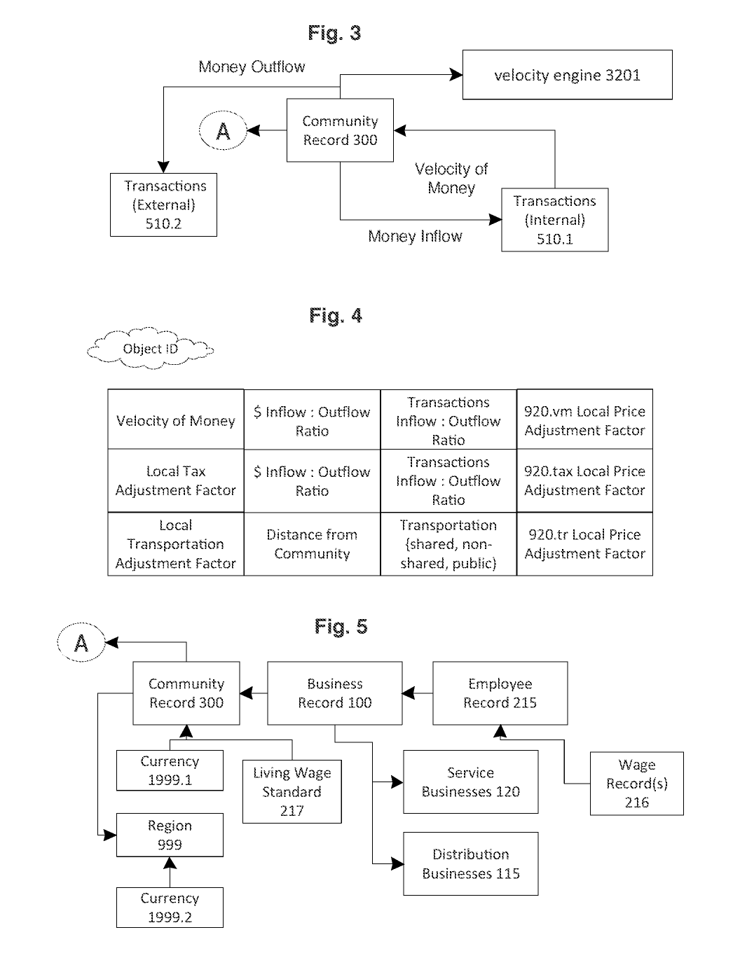

Turning to FIG. 3, FIG. 3 is a process flow that depicts money inflow(s) and outflow(s) from a community 300 centric perspective. The velocity of money is entirely about the recirculation of money/currency whether it be YoCal currency or regional currency through a series of internal transactions 510.1 where internal is in context to the local community. Each external transaction 510.2 outflow is value destroying in context to the local community, and at the very least for a sustainable community must be balanced by external transaction 510.2 inflows (not shown, an arrow from 510.2 to community 300 instead). Velocity of money turnover rates increase the relative value differential to the local community (which can be represented by YoCal currency rebates to reflect the leverage within the community). The calculation of velocity of money, which is based on historic transactions and economic modeling predictions, across the period of time in which the specific internal Transaction 510.1 has a positive impact on the Community 300 or in which the specific external Transaction 510.2 has an adverse impact on the Community 300 is performed by the Velocity Engine 3201 (typically hosted on the Community 300 server, though not shown in this figure).

Turning to FIG. 4, FIG. 4 is a detailed object structure for any item transaction (i.e., purchased) having an object id and a range of parameters collectively utilized to determine a Local Price Adjustment Factor 920 inclusive of 920.vm for the local velocity of money leverage factor as a function of dollars (i.e., regional currency) inflow to outflow ratio, number of transactions inflow to outflow ratio, and actual velocity of money; inclusive of 920.tax for the local tax adjustment factor as a function of dollars (i.e., regional currency) inflow to outflow ratio, number of transactions inflow to outflow ratio, and actual local tax transactions; and local transportation adjustment factor inclusive of 920.tr for the local price adjustment factor as a function of distance of product sourcing to the community in which the product is consumed (or projected/anticipated to be consumed in). More specific factors within the local transportation adjustment factor makes a distinction of both the type of transportation asset utilized for transport of the product being purchased, of the employee from residence to place of business, of the client from residence (or place of consumption) to place of business in which transportation asset can be a shared vehicle, a non-shared (i.e., private) vehicle, or a public transportation vehicle.

Turning to FIG. 5, FIG. 5 is another object data structure depicting both a local currency 1999.1 (i.e., YoCal currency) and a community 300 within a broader region 999 that utilizes a regional currency 1999.2. As noted in other figures, the business 100 (of type from service business 120, distribution business 115, or other types as depicted in other figures) in which transactions take place belongs to a community 300 and has employees 215. Each employee 215 has at least one wage record 216 that at the least depicts an hourly wage or hourly wage equivalent for which the business 100 pays the employee 215. The employee wage record 216 is particularly compared to the community 300 living wage standard 217, with the explicit intent of encouraging businesses 100 within the community 300 to leverage local currency 1999.1 to drive additional purchase transactions (i.e., profit to the business 100) recognizing that a business 100 that pays a living wage standard 217 that places less taxpayer burden on the community residence (not shown) to provide governmental (or charity or volunteer) services in order to make-up for wage deficiencies to live within the host community 300.

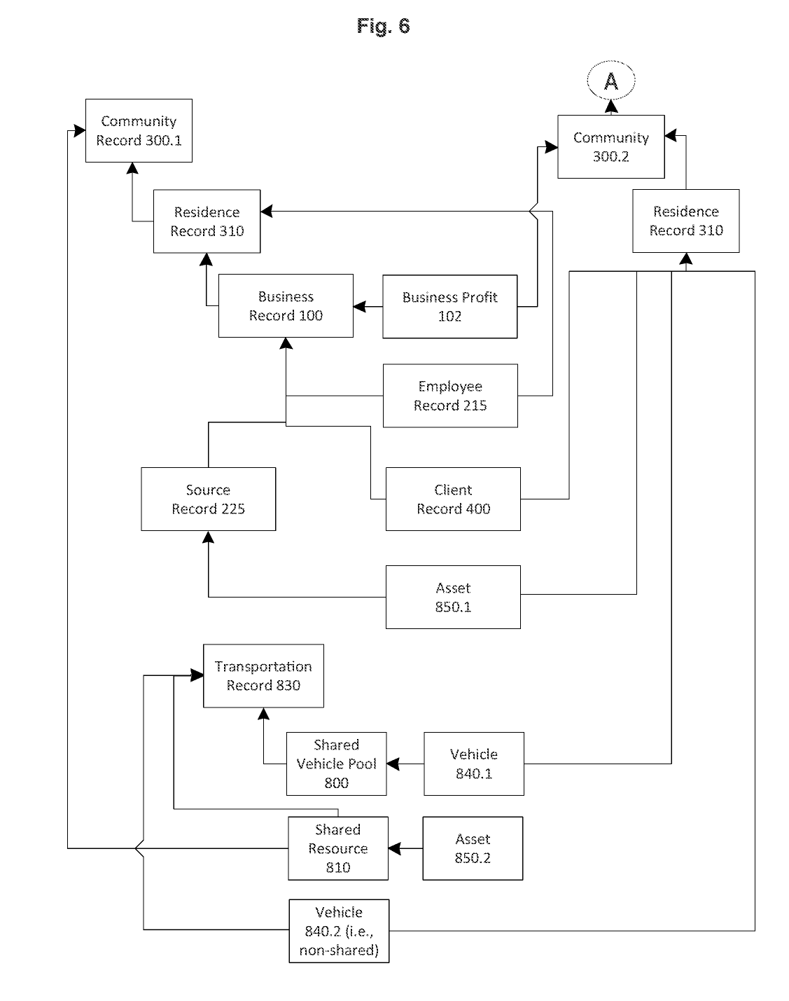

Turning to FIG. 6, FIG. 6 depicts another object relationship diagram that is employee centric. The business 100 is located within a community linked via its residence record 310 (i.e., physical “home”). In this instance, the business profit 102 is aggregated in this same community (i.e., either this business has a single location, or it has both an operating location as well as headquarter residence within the same community). It is understood that the business profit 102 center can be in another community. Each business 100 has at least one employee 215, where the employee is a residence 310 of a community 300.1 (in this instance). It is preferred that the employee is a resident of the same community in which the business is located, most notably that the travel costs (including environmental footprint therefore the energy intensity within the community) from the employee's apartment/home as well as the business's commitment to increasing the velocity of money within the community by way of maximizing the business's payroll in the same community. In addition, clients 400 conduct transactions with the business 100 such that at least purchased assets 850.1 (or non-service products) are provided to the client via logistics or the client's travel vehicle. The utilization of community assets, such as shared vehicle 840.1 from within a shared vehicle pool 800 (preferably owned by a community business or resident) has many benefits to the community of increasing asset utilization, obtaining return on investment within the community and very importantly reducing the outflow of currency all resulting in enhanced community velocity of money. The vehicle 840.2 is non-optimal and provides another scenario representing the current status quo being a personal ownership (or leasing) of a vehicle utilized both within and outside of a place of doing business. Unfortunately, the latter scenario is a decoupling of the comprehensive total cost of conducting a business transaction by having the actual transportation burden (e.g., fuel, amortization/lease of vehicle, etc.) does not lead to optimal decisions that maximize community value creation due to each transaction being “optimized” with an information deficit and lacking community burden (which therefore has a large reach of secondary consequences such as reduced property values in the long-term, etc.).

A preferred embodiment is in fact the minimization of personal asset ownership, therefore in fact avoiding/reducing the frequency of asset 850.1 acquisition at a business 100 but rather displacing that acquisition by utilization of asset 850.2 as available within a shared resource 810 pool. Though not shown in this figure, the shared resource asset 850.2 can be transported to virtually any place of business or even personal residence (preferably also via a vehicle 840.1 within the communities shared vehicle pool 800). Just as a shared vehicle increases asset utilization rates and diminishes currency outflows, shared asset 850.2 has the same impact on increasing community value. It is also optimal for the shared asset 850.2 to be owned by the same community in which the asset will be utilized in order for return on investment to stay within the community and reducing currency outflow (except in the rare instance in which the asset is 100% made and value-add within the community).

Assets (whether shared or not) can include a wide range of equipment, product to be consumed, product to be resold (i.e., when client is a wholesale account and the business is a distributor) or a financial instrument (e.g., insurance policy, savings account, mortgage loan, or business/personal loan) between a business and client. Importantly, the local impact parameter is a function of the type of asset as well as where the asset is deployed (i.e., purpose such as a biomass conversion plant producing energy and food byproducts that could be used within the host community or could be “exported” to another community providing regional currency (or barter of YoCal currency) to adjust for trade imbalances. It is further a feature of the invention such that terms of a financial instrument (e.g., loan) is a function of both the type of asset (e.g., energy or food production) and where the asset is deployed (i.e., within the same community or elsewhere) as deployment within the same community provides benefit to the community such that business obtaining the loan essentially lowers the risk of default through the community benefits.

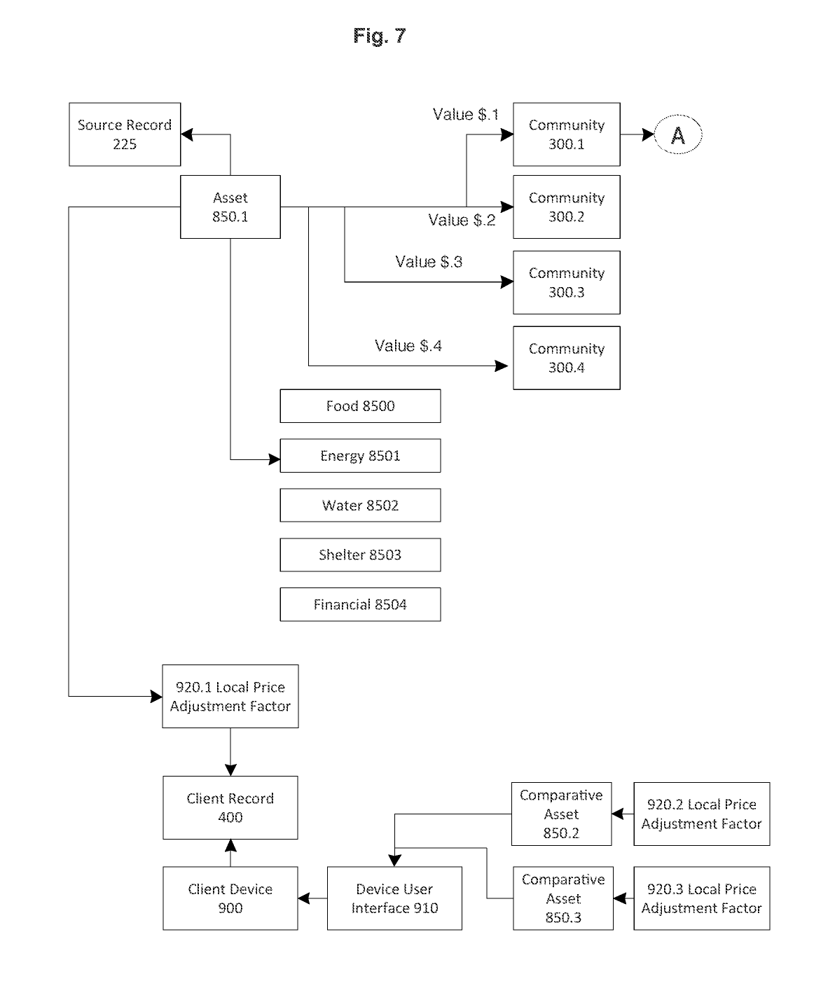

Turning to FIG. 7, FIG. 7 is another object data diagram from an asset centric perspective. The asset 850.1 is linked to a source 225 record (being the final place in which value-add has been created, i.e., place of manufacture) and yet the asset in most cases being an assembly in reality obtains value-add (and therefore creates value to the host community for that component) from multiple communities. Using the fundamentals established in other figures, the relative value of each component is linked to the respective communities (e.g., Value $0.1 to Community 300.1 . . . Value $0.4 to Community 300.4 etc.). The value of the asset upon acquisition, as noted from Value $0.1 through Value $0.4 (in this instance, though this limitation of number of communities is just for this example and not as anticipated in this invention), can be a function of the type of asset including food “production” assets 8500, energy “production” assets 8501, water “treatment” assets 8502, shelter “production” assets 8503, and financial “service” assets 8504 as well as the plethora of product for consumption assets in which known-in-the-art asset/product characterization is followed. The local price adjustment factor 920.1 is a function of where the asset was produced and the relative value to the community (vs. other communities), how it will be used (e.g., production equipment, or consumed), where it will be used (i.e., external of community or within the community), who owns the asset and whether the profits from that ownership is reinvested in the community or external of the community. The local price adjustment factor 920.1 is client 400 specific, including client specific information including client's residence, client's employment, and client's mode of transportation to the business 100 place of transaction. The local price adjustment factor 920.1 is then also a function of comparative assets (e.g., 850.2, 850.3) such that multiple related parties can modify what local price adjustment factor 920.1 is passed on and transmitted to the client. In the event that comparative assets (which can be viewed as alternatives, substitutes) are either not readily available or aren't competitive even at the non-discounted local price adjustment factor then the community, the state, or the country in which the business is located in (or community in which the client has residence or elects to deploy the acquired asset) can elect to choose any percentage from 0 to 100% of the local price adjustment factor. It is understood that a local price adjustment factor 920.1 can be provided for each level of “local” such as at the community level, or the city level in which the community resides, or the state level in which the community resides, or even at the country level in which the community resides (with the latter being essentially a negative tariff for “local” purchases). The total price based on regional currency and local currency, which includes the local price adjustment factor is then transmitted to the client device 900, as known in the art, to be displayed on the client device user interface 910 (as known in the art to be any method of displaying or communicating at least the relative price to the client 400 so the client can make an assessment accounting for local impact in an objective manner with comparative assets (850.2 and 850.3) having their total price and respectively local price adjustment (920.2 and 920.3). The user interface can display a simple green (indicating superior impact on local) or red (indicating poor choice) to a more comprehensive analysis providing line item (with parameters) relative comparison.

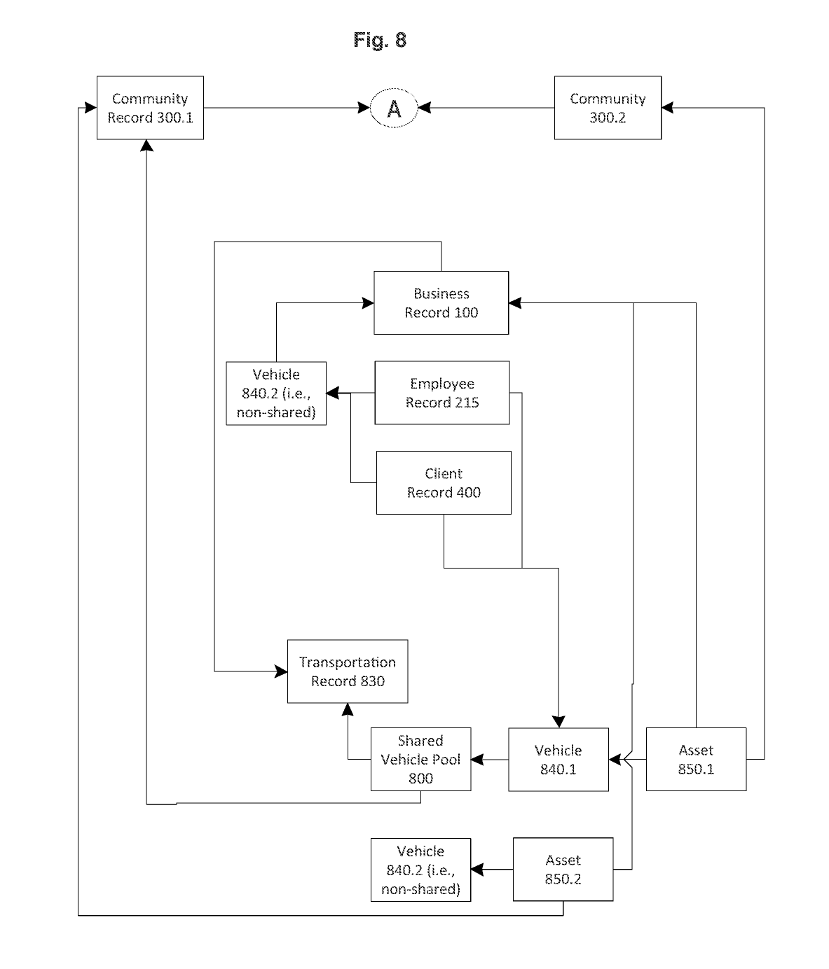

Turning to FIG. 8, FIG. 8 is an object diagram that is transportation vehicle centric. Logistics cost, which in reality must account for both asset 850.1 & 850.2 inbound as well as outbound from both a cost perspective as well as a community impact though prior art only takes into account inbound logistics into the business 100. The transportation 830 record has at least two instances of one for inbound and one for outbound (which in many instances is not known in advance, therefore must use either a projection based on client 400 historic records or client 400 indicated parameter(s). Inbound logistics is preferably based on a community-based vehicle 840.1 within a shared vehicle pool 800 owned by either an employee 215, the business 100, the client 400 or more preferred to be a community owned vehicle. In an instance, the vehicle 840.2 is driven by employee 215, which is typical of using a business owned asset to obtain product (i.e., assets) for sale from either a wholesaler or distribution warehouse. The optimal embodiment of the invention is to incorporate parameters for the local price adjustment factor so as to account for total cost of logistics (including inbound) such that assets that are brought into the host community at least maximize their utilization of other community assets, which would be a vehicle from within a community owned (and operated) shared pool. This embodiment is particularly relevant as the world moves to autonomous or semi-autonomous vehicles, and a particularly preferred embodiment such that the vehicle is dynamically reconfigured to accomplish “last” mile logistics within the community. It is understood that multiple embodiments of different relationships between vehicles, business, client are anticipated, but the core invention is that local price adjustment factor first accounts for fully inbound and outbound logistics cost and secondly such that maximum community impact is achieved by also establishing relative community impact (and translating this into quantitative price adjustment through local currency) between a transaction of a first asset to alternative or substitute assets.

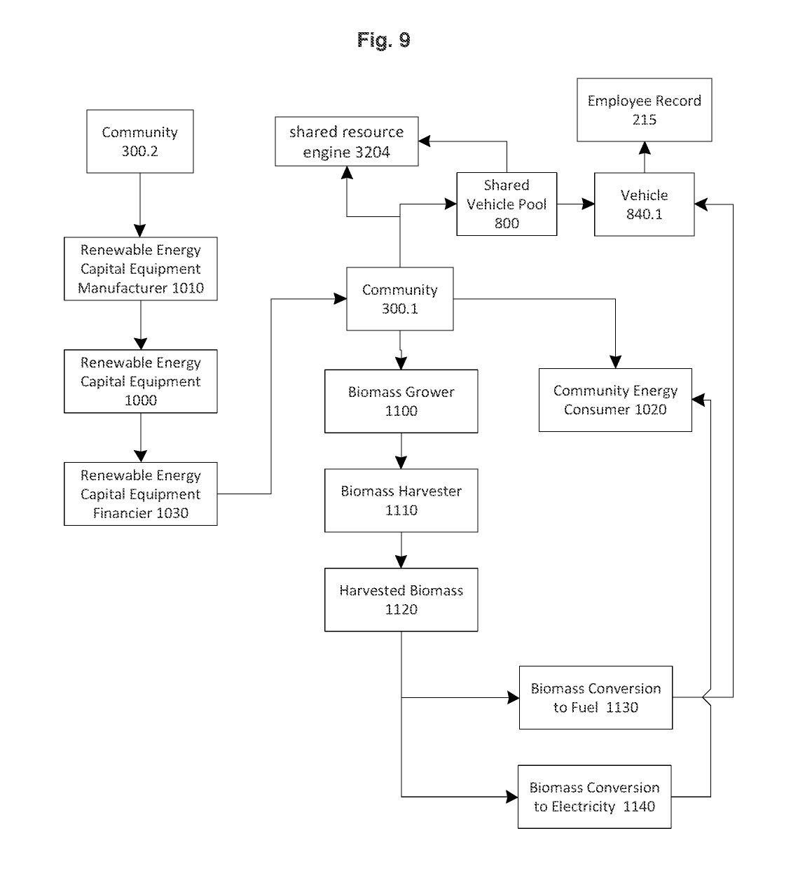

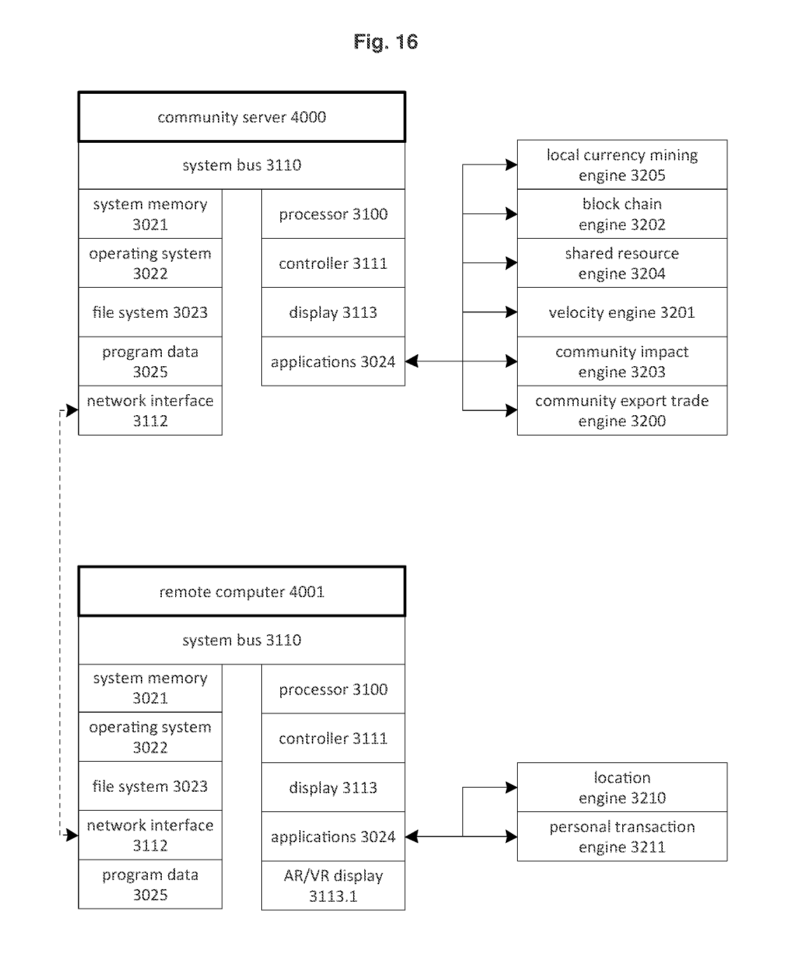

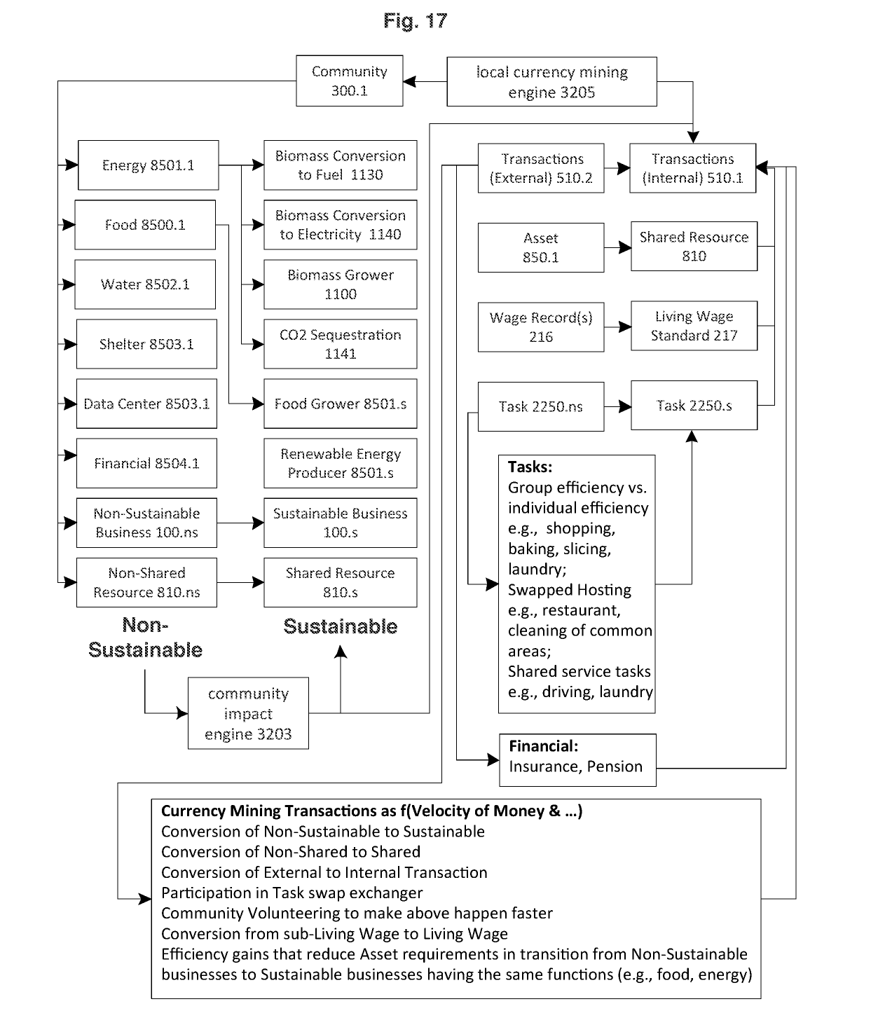

Turning to FIG. 9, FIG. 9 is an object data diagram from an energy centric perspective. Energy cost are a critical element to a sustainable community from both a fiscal as well as environmental perspective. The community 300.1 (the “current” centric host) can acquire renewable energy that is generated from an external second community 300.2 using renewable energy capital equipment 1000 manufactured by a renewable energy capital equipment manufacturer 1010 external of the current community 300.1 which is subsequently placed in the same external community 300.2 (alternatively though not shown, the capital equipment 1000 can be manufactured within a third community separate from where the renewable energy capital equipment 1000 generates energy) to generate renewable energy (e.g., solar, wind, hydro, etc.). This aforementioned equipment is relatively (at least to biomass derived energy) capital intensive thus requiring renewable energy capital equipment financier 1030 (which in this exemplary case is also external of the current community 300.1. This scenario is significantly disadvantageous to cash flow by leading to long-term cash outflows from the current community 300.1 to an external community 300.2 (or alternatively any external community, though not shown). The Shared Resource Engine 3204 is an application on the Community 300.1 server, as shown in FIG. 16, which coordinates the scheduling of Vehicle(s) 840.1 (preferably an owned asset by the Community 300.1, but could be leased or even temporarily pooled as a shared resource), monitors the location of the Vehicle(s) 840.1. The Shared Resource Engine 3204, though not shown in FIG. 17, also coordinates scheduling and monitoring of Shared Resource 810.s or 810 and Asset(s) 850.1.

The other exemplary situation depicts the preferred embodiment of biomass produced energy. The particularly preferred scenario is for the harvested biomass 1120 to be grown within the current community 300.1 by a biomass grower 1100 that is subsequently harvested by a biomass harvester 1110 (also preferentially within the current community 300.1). Biomass energy production has substantially lower capital costs than traditional renewable energy (e.g., solar, wind) though higher operating costs in the form of harvested biomass 1120. However, in this embodiment the bulk of the harvested biomass 1120 operating costs are within the community 300.1 thus contributing to both local cash flow and increased velocity of money within the current community 300.1. It is understood that any of the biomass processes from growing, harvesting, to biomass conversion to fuel 1130 (i.e., transportation fuels to operate mobile vehicles or non-co-located power generation assets) significantly increases the value relative to the harvested biomass 1120. Alternatively, the harvested biomass 1120 is further processed into biomass conversion to electricity 1140 for locally consumed energy (or alternatively transmitted via electrical distribution/transmission lines into a second community (e.g., 300.2). Though the value increase from harvested biomass 1120 to electricity (via process 1140) is less than conversion process to fuel 1130, the consumption of electricity by community energy consumer 1020 is virtually entirely within the local current community 300.1 greatly contributing to local velocity of money. It is understood, though not shown, that the electricity produced by process 1140 can be distributed external of the current local community 300.1 to any second community such as 300.2 that has the advantage of increasing the cash inflow (i.e., through exports) into the local community 300.1 leading to additional velocity of money benefits realized within the local current community 300.1. In the instance of transportation fuels from biomass conversion to fuel 1130 process where the produced transportation fuel is consumed within the local community by a vehicle 840.1. It is optimal when the vehicle 840.1 is part of a shared vehicle pool 800 to increase the capacity utilization factor of the vehicle 840.1, and it is further optimized when the vehicle is used by an employee having an employee record 215 (where, though not shown, the employee works within a local business within the local current community 300.1.

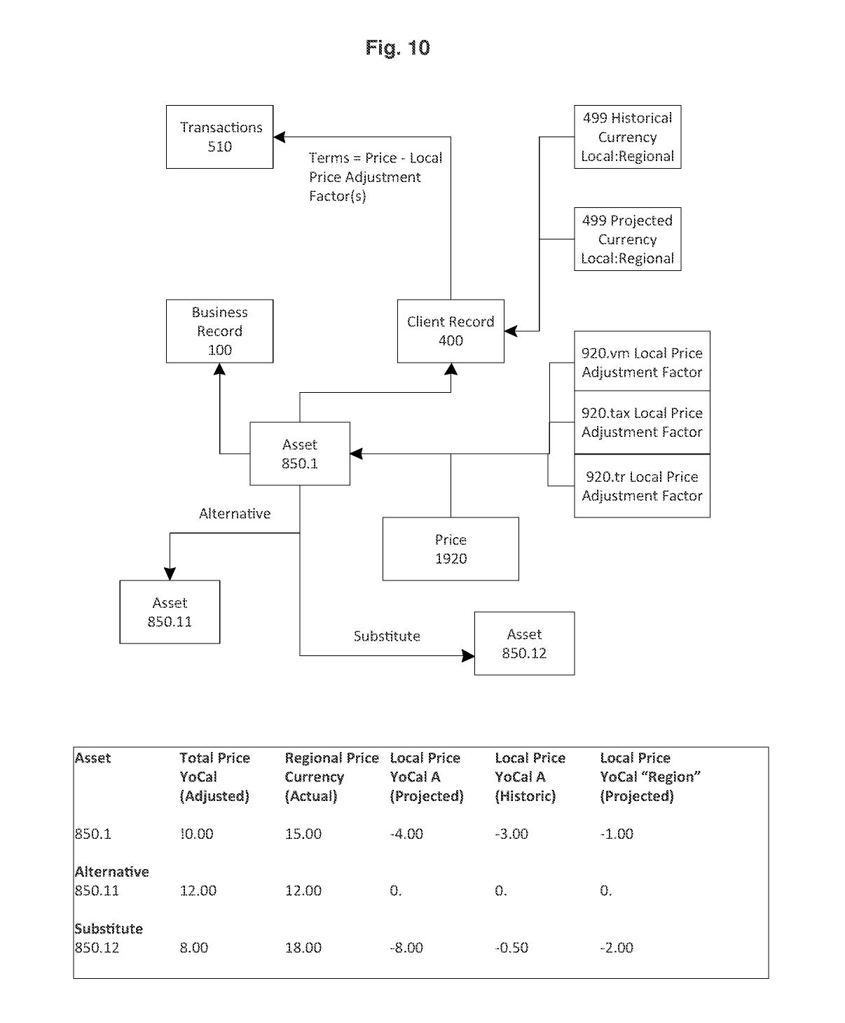

Turning to FIG. 10, FIG. 10 is the fundamental pricing mechanism that accounts for benefits realized by the host community (though not shown) in which the business 100 and its clients 400 conduct business. This embodiment shows an asset 850.1 being acquired by a client having a client record 400 at a business having a business record 100. It is shown, and understood that many products (i.e., assets) have alternative product options such as 850.11 or substitute product options such as 850.12. It is a primary objective of the pricing mechanism to show for comparison purposes asset prices that are adjusted by 920.vm for local price adjustment factor taking into account local content and its direct (and indirect) impact on velocity of money leverage within the host community. It is also a primary objective of the pricing mechanism to show for comparison purposes asset through 920.tx having local price adjustment factor through taxes on this transaction (i.e., analogous to sales tax whether it be state, county, etc.). Yet another objective is to adjust the asset price 1920 through 920.tr local price adjustment factor in the regional local currency, which is analogous to a rebate but entirely driven on the impact of community value creation as linked to the leverage of velocity of money within the local current community (though not shown 300.1) and not about encouraging increased sales to the business 100 in which the transaction takes place. A very important element of the velocity of money community leverage value creation via pricing mechanism for each transaction 510 takes into account a fundamental Price that then accounts for all of the Local Price Adjustment Factor(s). Further, the Local Price Adjustment Factor(s) are a function of the client having client record 400 having a history of transactions represented by 499 Historical Currency Local (i.e., neighborhood, and broader region “Regional” e.g., county, state, country, etc.). Dedicated clients having persistent loyalty to local businesses 100 as shown by their 499 Historical Currency Local: Regional transaction records has a further impact on the Local Price Adjustment Factors, in addition to 499 Projected Currency Local: Regional transactions for the future. It is known in the art that a wide range of factors either predicted or known variances can then predict deviations from the historic records. The table within FIG. 10 depicts the price and price variations for both within traditional currency and locally adjusted currency through local (i.e., YoCal currency). In this instance, the table shows relative price for the product purchase (i.e., Asset 850.1) versus alternative (i.e., Asset 850.11) and substitute (i.e., Asset 850.12). The Total Price YoCal (i.e., the adjusted price) depicts the transaction price when the asset has no local content contribution (and therefore no local price adjustments) being Regional Price Currency (Actual) minus all local price adjustments based on projected records calculated as the Local Price YoCal A(djustment) utilizing projected client local content loyalty (which in this instance is higher than otherwise based on historic records). The Local Price YoCal “Region” (Projected) takes into account local content incrementally beyond the smallest local region (e.g., neighborhood) into the Region (e.g., county, state, etc.). Though not shown, it is understood that every level of local starting from neighborhood to state or even country can have a price adjustment. The fundamental goal of the YoCal pricing mechanism is to encourage local transactions even (or especially) when products manufactured without any local content having an incremental lower purchase price are foregone for products having at least relatively more local content. The community realizes real economic benefits by achieving a higher velocity of money leading to real community wealth creation, therefore providing a real calculated adjustment in the form of YoCal (i.e., local currency) instant rebate. The community supports this price adjustment as it truly realizes gains due to the community impact of the purchasing transaction due to local content.

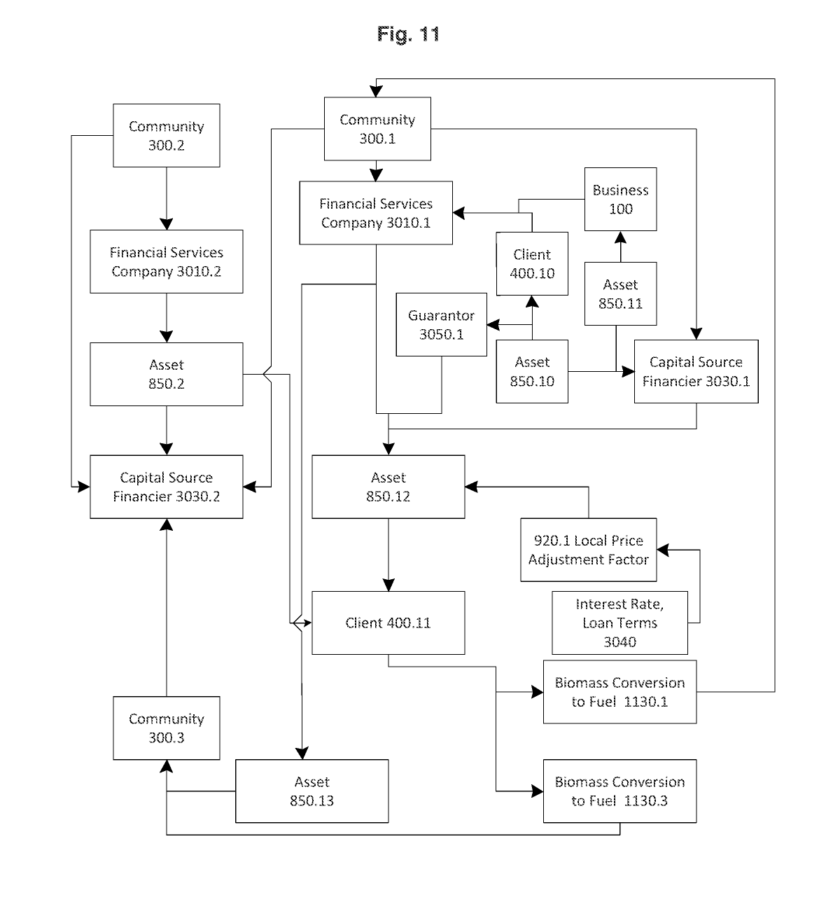

Turning to FIG. 11, FIG. 11 depicts the impact of local transactions through a financial service company 3010.1 centric perspective. The preferred embodiment is such that the financial service company 3010.1 is effectively a local bank coop or credit union such that all entities, from local businesses 100 to local clients 400 are highly encouraged to conduct business with this financial service company 3010.1 by providing preferred financial terms, whether the transaction be deposits, loans, or simply purchase transactions. The financial service company 3010.1 preferably has its profit center, and more importantly its profit reinvestment center, within the host local current community 300.1. In the event of the financial service company 3010.1 being a local coop/credit union, it is understood that aspects of the financial transaction may be disintermediated such that a client 400.10 may own a residence, such as asset 850.10 that can be utilized as collateral for a second transaction within the same host community 300.1 thus serving as the guarantor 3050.1 for this second transaction (which is a loan for asset 850.12) to client 400.11.

In this instance, the asset 850.12 enhances the velocity of money, and therefore the community wealth within the host current community 300.1, by producing biomass into fuel largely consumed within the host current community 300.1 via biomass conversion to fuel 1130.1 process(es). This instance for asset 850.12 will have a higher local price adjustment factor 920.1 as compared to when the asset 850.13 is placed into an external community 300.3. An intermediary local price adjustment factor 920.1, which includes loan terms of the financial transaction including interest rate 3040, is when the asset 850.12 remains within the host current community 300.1 but largely for the benefit of an external community 300.3 exemplary of the asset 850.12 being used within a biomass conversion to fuel 1130.3 process(es) where the resulting fuel is utilized in the external community 300.3. The local price adjustment factor 920.1 is also influenced by the provider of the capital source financier 3030.1 as shown in which the cash flow in accordance to the terms of the loan transaction remain within the community 300.1 (as compared to a financier external 3030.2 within community 300.2). The aforementioned loan can be substituted to be a business 100 rather than a person (client 400). It is a primary objective of the financial currency system to maximize cash flows within the host community, and therefore the financial terms of the transaction (e.g., interest rate, loan terms 3040) are translated into local price adjustment factor(s) 920.1 that are maximized when all parties of the transaction AND all beneficiaries of the asset placement reside within the same host current community. Though depicted in this figure as a loan transaction for a business asset (i.e., a productive asset, as opposed to a consumer asset having no benefits to the host current community), the anticipated financial transactions include insurance transactions and particularly insurance transactions when the partial or complete loss of the asset insured can be repaired or replaced in full (preferably) or in part by residences (e.g., client 400) or businesses (e.g., business 100) such that the cash flow (e.g., payments for insurance) remains within the community at best, or such that the insurance provider at least makes a commitment to achieve the repair or replacement by maximizing the resources and assets within the host current community. In this instance, the insurance transaction reflects the velocity of money and community wealth creation resulting in a local price adjustment factor.

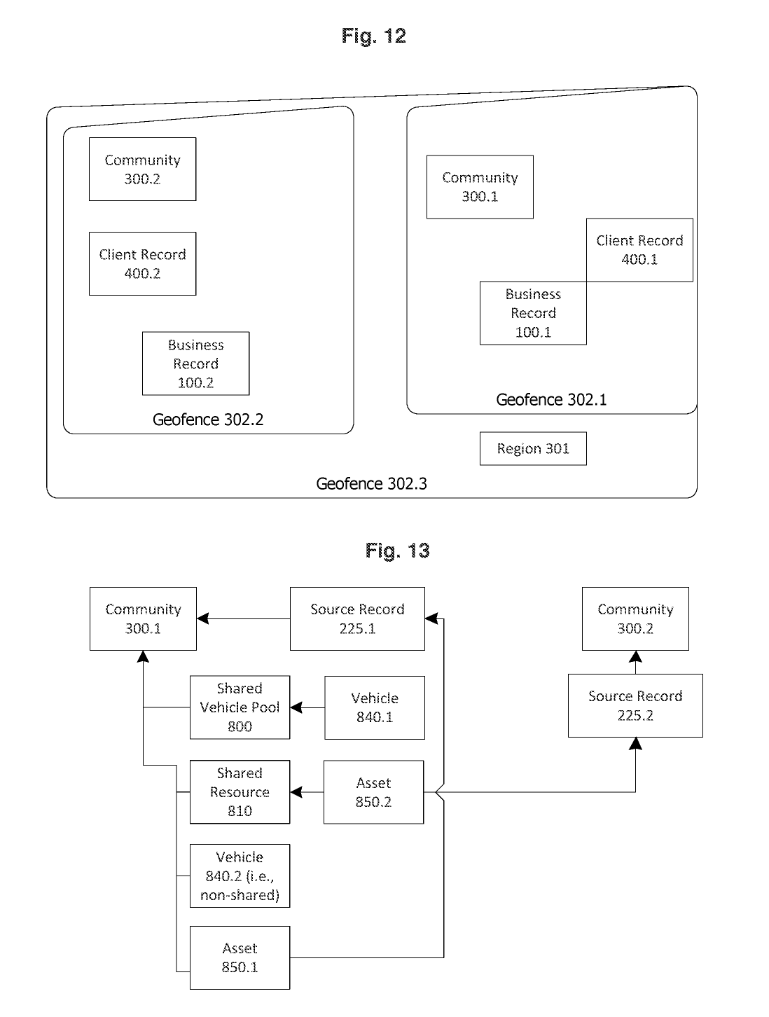

Turning to FIG. 12, in FIG. 12 depicts the exemplary representation of an object (e.g., client as represented by client record 400.1 and business as represented by business record 100.1) being physically located within a host current community 300.1 being within (and therefore defining the region of “host current”) a geofence 302.1. It is recognized that any object including assets 850 (not shown) are also defined by their respective physical location within a geofence 302. It is shown geofence(s) 302.1 (i.e., neighborhood) can be nested within another geofence 302.3 to represent a region 301 (i.e., city or village) and this process of nesting can repeat itself multiple times (though not shown, e.g., neighborhood within village within county within state within country and within continent). Regions can also be utilized in instances where adjacent neighborhoods (e.g., 302.1 and 302.2) may be different states due to border proximity and yet represent the same region (e.g., Native American reservations that are in 2 different states) and clearly need to be the beneficiaries of preferring local transactions through local price adjustment factor(s).

Turning to FIG. 13, FIG. 13 depicts exemplary assets within a shared resource pool, where the assets are within a general shared resource pool 810 of assets 850 (i.e., non-mobile/stationary except by external logistics providers) and mobile assets within a shared vehicle pool 800 of vehicles 840. The shared resource component of the financial velocity of money system makes a distinction between the ownership of the asset being within the host current community 300.1 or external of the host current community 300.2 through a source record 225.1 or 225.2 respectively. The system establishes preferential local price adjustments for assets of all types that are made available into the shared resource pools (e.g., 840.1 or 850.2) over non-shared assets (e.g., 840.2 or 850.1). The maximum local price adjustment factor, all other things equal, are for assets that are owned (and if financially loaned by a financial service company also within the host current community) within the host current community, made available to all within the host current community through a shared resource pool (to maximize utilization factor as well as community wealth creation, while minimizing environmental impact). Shared resources are of particular importance to the financial velocity of money system, as most communities (particularly neighborhoods) do not manufacture their own capital assets or consumer appliances. Therefore, the utilization of these capital assets (e.g., automobile vehicles) or consumer appliances (e.g., lawn mowers, washing machines, etc.) within shared resource pools greatly reduces the number of these assets owned (or leased) within the host current community which directly reduces cash outflow from the community by increasing the frequency of use and the utilization factor. Having ownership of these assets within the community also reduces the cash outflow due to financing, which otherwise further exacerbates the adverse impact of velocity of money within the community.

The resulting financial local currency system with integral local price adjustments is an invention that is a fundamental requirement for a triple bottom line sustainable community, especially one built on socio-economic justice. The resulting sustainable community with true socio-economic justice further integrates universal basic income (as known in the art, and also generally referred to as society adjusted income) effectively has two (though currently decoupled) transaction costs associated with every purchasing transaction, with the first being direct business transaction (i.e., independent of any externality beyond business itself and traditional taxes) being void of any factors adjusting for local velocity of money impact for the object/asset being acquired, and the second being traditionally entirely invisible (i.e., void) between the client and business but is material to the social/governmental cost of the transaction. The complete decoupling of the business transaction cost and the societal government transaction cost prevents the client from making purchase decisions that reflect the true cost of choosing the purchase of one asset from another and therefore not being able to maximize the community wealth in which the business transaction takes place. The invented financial local currency with velocity of money system integrates both the business transaction costs and the socio-economic cost (or benefits) resulting from the leverage of velocity of money impact within the host current community. A client that lives in a long-term sustainable community has significant economic impact by maximizing the acquisition of locally optimized assets, including a long-term increase in value of personal property (e.g., residence). The goal of the invention is to utilize local adjustment pricing factor “YoCal factor” to reflect real (though projected) value (i.e., community wealth creation) created within the host current community achieved by the leverage due to higher velocity of money within the host current community, such that the YoCal factor provides the client with local currency based on the velocity of money (i.e., community net impact) to offset at least some (though preferably all) of the otherwise cost advantage of choosing to purchase a non-locally sourced asset. It is understood that purchase of locally sourced assets is not necessarily disadvantaged to non-locally sourced assets, therefore it is a feature of the invention to utilize a Local vs. Non-Local Purchase Adjustment Differential to reduce the YoCal factor that minimizes or eliminates the effective discount through YoCal local currency adjustment when it isn't necessary.

Another aspect of the invention, particularly within the scope of invention including socio-economic justice and universal basic income, is the use of YoCal local currency and the local price adjustment factor to encourage purchase decisions between alternative assets (or consumables) beyond its local content but also inclusive of price adjustments that impact societal expenses based around universal basic income such as food, healthcare and education. YoCal price adjustments are biased to encourage healthy food consumption with high nutrient content over relatively nutrient-deprived foods that often drive higher healthcare costs.

Yet another aspect of the invention, particularly when automation of jobs or tasks are taking place through a purchase transaction of a robot, is to incorporate a YoCal local price adjustment penalty as this transaction leads to a significant adverse socio-economic cost on the host current community UNLESS the automation is enabling subsequent benefits that enhance the velocity of money and/or community wealth creation. An exemplary automation task would be animal meat processing (e.g., poultry, fish, etc.) tasks that are highly undesirable yet enable the economic meat production (i.e., growing) of poultry utilizing locally sourced animal feed such that the economic advantage of reducing/eliminating the cash outflow necessary from poultry purchase from non-locally sourced communities and the increase in demand for locally sourced animal feed (or at least animal feed ingredients) within the host current community. The financial local currency system encourages investment in assets, preferably from local profits to further drive the sustainable community into increasing amounts of self-sufficiency, renewable energy production, and decreasing amounts of community expenses such as factors that adversely impact health (e.g., high cost of high-nutrient produce, as compared to low cost grain commodities such as corn, wheat, and rice that are relatively nutrient deprived). A positively impactful asset is a locally placed greenhouse, vertical farm, or biomass conversion production plant. These aforementioned assets are often associated with highly repetitive tasks that are not intellectually stimulating, yet offset purchases that otherwise have to be from external of the community (and therefore cash outflows). Other exemplary tasks that are both repetitive and not intellectually stimulating include milking cattle/goat, slicing/preparing fresh ingredients for salads and healthy stir-fry meals, removing weeds or fertilizing from garden or lawns.

It is understood that augmented reality is a primary method to show to end user (i.e., client) the variation of pricing for both traditional regional currency and YoCal local currency as personalized for 1) local as determined by end user (i.e. customer), 2) local as determined by location of place conducting business, and 3) local as determined by location of business profit center. This is shown relative to other products within the same type I category, etc. The pricing including velocity of money impact and local pricing adjustment factor(s) are also relative to alternative/substitute products that have increased local content to promote increase consumption of products with greater sustainable community local impact.

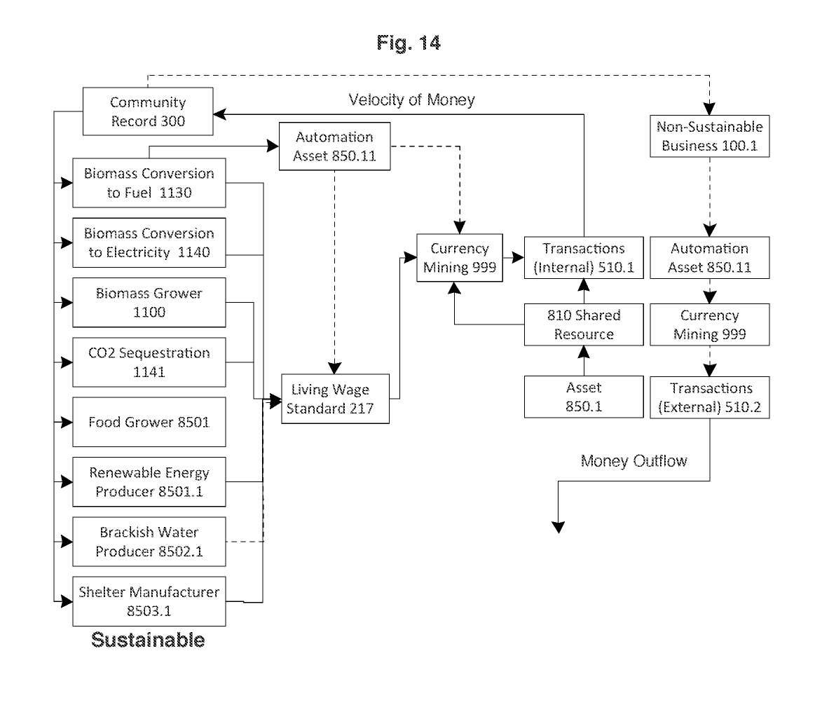

Turning to FIG. 14, FIG. 14 depicts the data structure supporting the local Currency Mining 999 (analogous to cryptocurrency mining). A fundamental differentiation of the inventive currency mining method is a direct linkage to an investment and transition from non-sustainable assets to sustainable assets within the host community 300 record and exemplary in this figure includes renewable (and sustainable) energy assets to convert biomass to fuel 1130, biomass conversion to electricity 1140, biomass grower 1100 production assets that produce and then harvest biomass for the aforementioned biomass conversion processes 1130 and 1140. Traditional renewable energy producer 8501.1 assets include exemplary assets of solar, wind and hydro power. The addressing of greenhouse gases, as known in the art, is vital to reducing climate change and therefore CO2 sequestration assets 1141 are vital to a sustainable economy. The pillars of sustainable practices center around the energy, food, and water nexus therefore the investment in local food grower 8501 production assets is essential with exemplary assets being vertical farming, aquaculture, hydroponics, and greenhouses. Water processing inclusive of brackish water producer 8502.1 assets increases the availability of water that is vital to food production and virtually every modern society inclusive of concrete production such as utilized in the creation of shelter manufacturer 8503.1 production assets that have the ability to provide highly integrated housing for the host community 300. A successful sustainable community 300 engages in the practice of providing jobs that pay at a living wage standard 217 (which is also known in the art as universal basic income). The inventive system that issues (i.e., mines) new local currency is furthermore linked to the investment of the new aforementioned sustainable assets and establishes further (and optional) increases in mined currency when such asset investments are made concurrently with (or supported by) employment at or in excess of the living wage standard 217. Opposite in terms of sustainability in the community 300, which is a viable employment for residences (not shown in this figure), is the potential (and optional) concurrent investment in automation asset(s) 850.11. The dashed line linking the automation asset to both the living wage standard 217 and currency mining 999 system/engine to the respective sustainable asset (which in this case is shown as biomass conversion to fuel 1130) is indicative of a potential penalty (or reduction of mined currency) to at least partially counter the benefits realized by the investment in sustainable assets. It is understood that each of the exemplary sustainable assets are in reality linked to any concurrent automation asset(s) 850.11 though only the top biomass conversion to fuel 1130 asset is depicted in full. Furthermore, each transaction recognizes that a sustainable community 300 can be penalized in terms of currency mining 999 when the investment is for non-sustainable business 100.1 assets and especially when such assets are automation asset(s) 850.11 further linked to the currency mining 999 and particularly for the linked external transactions 510.2 (i.e., meaning that currency is leaving the community) as a money/currency outflow. Yet another inventive feature of the currency mining 999 engine is for the utilization of asset(s) 850.1 linked to and used as a shared resource 810 asset. As known in the art, a shared resource 810 asset are sometimes referred to as rental or public assets. Particular preference is provided to community (or coop) owned assets that serve the broader community, which is of particular benefit to the community as many shared resource 810 assets are both often acquired via external transactions (e.g., 510.2) such as automobiles, consumer appliances, etc. The utilization of shared resource(s) 810 as manufactured outside of the host community 300 increases the utilization rates of the assets and limits the otherwise necessity of residences of the community from acquiring additional like assets and triggering additional external transactions. As shown in this FIG. 14, an asset 850.1 within a pool of shared resource 810 assets are linked (and processed) as an internal transaction 510.1 to clearly have a net positive impact on Velocity of Money within the host community 300. A fundamental differentiation from the prior art is summarized as the issuance/mining of local currency (analogous or inclusive of cryptocurrency) is the: a) linkage to physical assets and particularly physical assets that increase the host community velocity of money, 2) linkage to physical assets that decrease the outflow of money/currency external of the host community, 3) linkage to physical assets that promote the increase of wage growth equal to or in excess of the predominant living wage standard within the host community, 4) linkage of penalties for transactions that promote automation particularly in non-sustainable businesses, and 5) avoidance/absence/void of high energy consuming electronic computing measures that perform a large number (greater than 100) of calculations using said electronic computing measures acquired via external transactions that themselves reduces the community velocity of money and further reduce the community velocity of money through the acquisition of significant electricity (of at least 100 times greater than the community velocity of money engine/server).

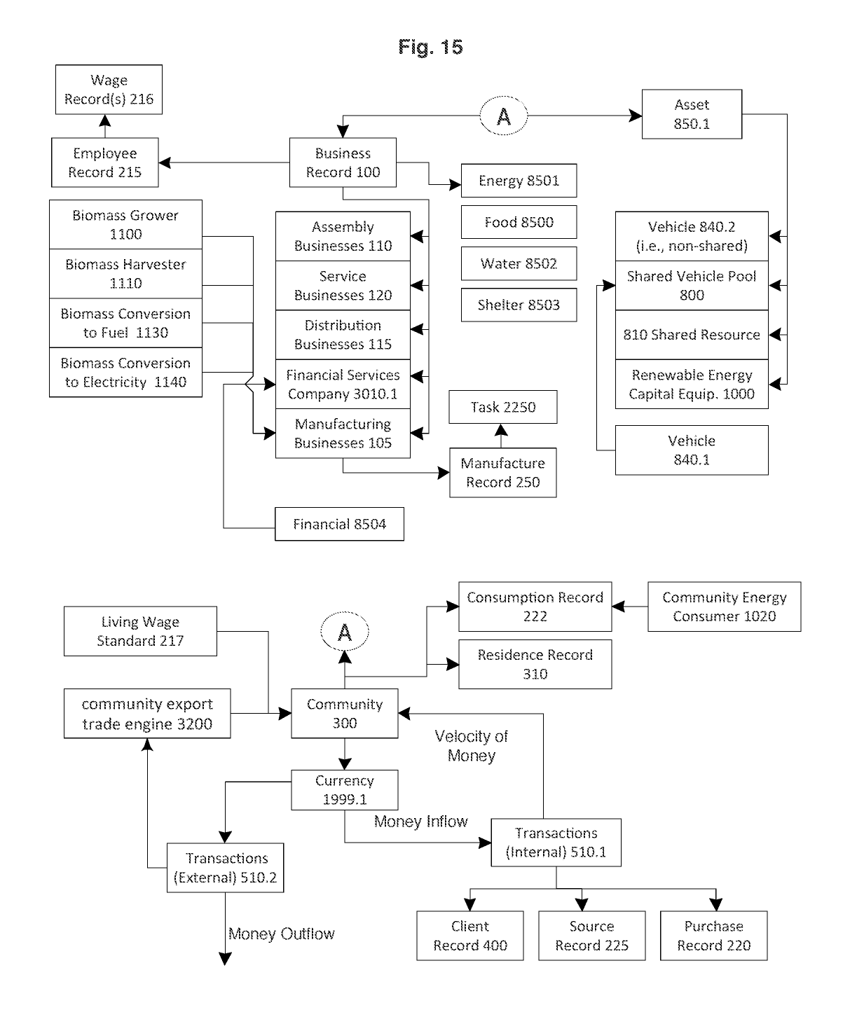

Turning to FIG. 15, FIG. 15 depicts the data structure around a business 100 entity (record) within the host community 300 (record linked via “A” between the two portions of this Figure, and further understood that any instance of community 300 as shown in other figures is also linked via data structure/architecture whether “A” is shown or not). Each business 100 entity is categorized by at least the product categories of energy 8501, food 8500, water 8502, shelter 8503 (all preceding are indicative of business categories vital to a sustainable community). It is understood that this FIG. 15 shows the business 100 as falling with and linked to the category of energy 8501 businesses (though further understood that the business can be linked to other categories e.g., food 8500, water 8502, etc. though not shown). The business 100 is further categorized by the type of scope of business operations inclusive of the operations categories of assembly businesses 110, service businesses 120, distribution businesses 115, financial services business/company 3010.1 or manufacturing businesses 105. This figure shows the business 100 as linked to all of the scope of business operations, though it is understood that most businesses will fall into just one scope of business operation categories. Yet further categorization of the business 100 is provided for of special note sustainable business classifications of biomass grower 1100, biomass harvester 1110, biomass conversion to fuel 1130, or biomass to electricity 1140. A further aspect of the invention and data structure is the direct linkage of the business 100 with its employees 215 and further linked to its wage 216 structure (and records). It is a fundamental principle of the invention that each and every business has an execution strategy and plan that directly impacts the velocity of money within the community 300, ranging from encouragement of employees to utilize transportation assets 850.1 to commute to their workplace of business 100. It is recognized in the invention that transportation assets 850.1 are best when the transportation asset is a vehicle 840.1 that is part of a shared vehicle pool 800 as compared to a vehicle 840.2 being a non-shared asset classification. It is yet further advantageous for commuting to leverage a shared resource 810 such as a public bus or train. And it is yet further advantageous for the transportation vehicle to be powered by energy produced by a renewable energy capital equipment 1000 asset.

Another aspect depicted in this FIG. 15 is a record for each task 2250, which is as shown being linked to a manufacturing 250 record for each asset manufactured. It is understood that every business has a series of tasks 2250 associated with its scope of operations, though for brevity only depicts tasks linked to manufacturing operations 250.

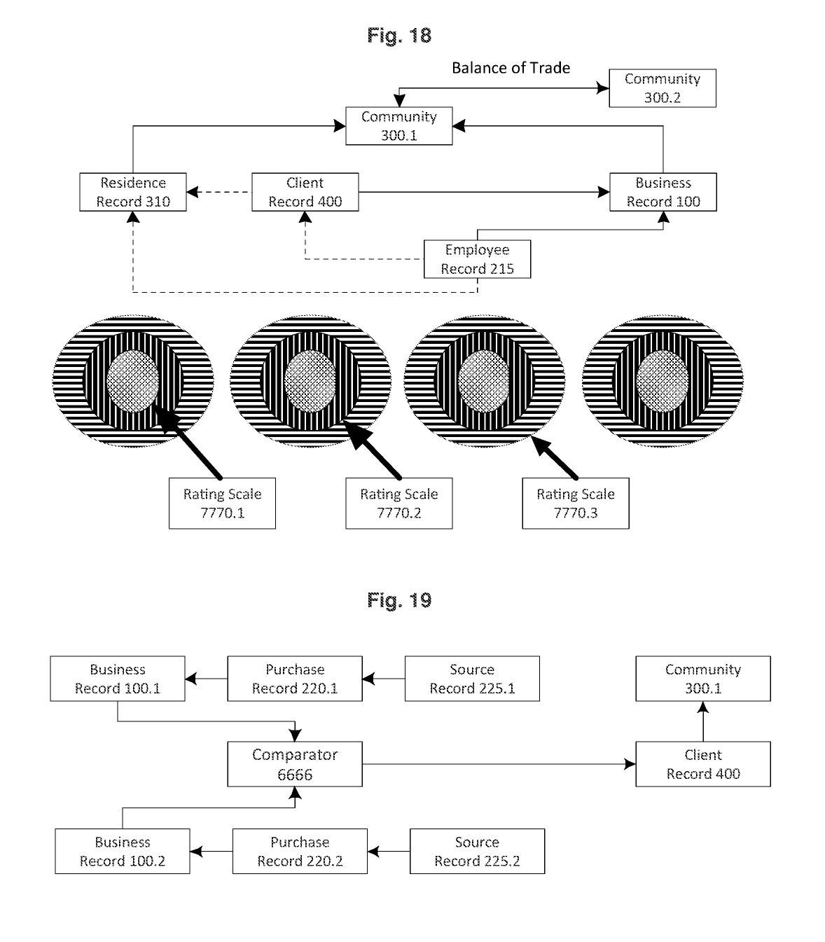

The lower portion of FIG. 15 depicts additional data structures linked (i.e., parent-child object relationships) to the business 100 record. Each business 200 has a record of all acquisitions particularly acquisitions in which products/assets are manufactured (particularly preferred, or at least sourced) locally. Of notable preference are products/assets (or even services) that are provided through local business entities with specific preference to products/assets sourced through community owned (i.e., public) assets or shared resource assets such as community energy consumer 1020. Each business 100 also links its clients and particularly clients that are residence 310 of the same community in which the business resides in a database record. It is an aspect of the invention that each business 100 has a multi-factorial rating system (as shown in FIG. 18) in which parameters factoring into that rating system include the business' consumption sourcing 222 from its host community residence 310, marketing policies to encourage customer (via link to residence) sourcing from local sources to the business residence 310 community, purchasing policies such that product not available (i.e., external transactions 510.2) from within the residence 310 community are preferably made with communities that have a preferred balance of trade relationship which are coordinated through the community export trade engine 3200. Each and every transaction made (whether internal or external, but required for all internal 510.1) is linked to the client 400 conducting the transaction, linked to the product via its originating source 225 and through the purchase 220 record via its vendor/supplier. The fundamental business rating system is a function (of time) and parameterized to maximize velocity of money of all transactions conducted by the business, its clients 400, its suppliers by purchase 220 records through source 225 records and to further maximize currency 1999.1 inflows via internal transactions 510.1 as opposed to external transactions 510.2 (i.e., money outflow).

Turning to FIG. 16, FIG. 16 depicts the hardware implementation of the inventive system. Though shown as a singular community (computer) server 4000, it is understood in the art that the server can (and is likely) to an array of servers in at least one datacenter (in which the datacenter is preferably also within the host community but includes remote servers at remote i.e., public or private cloud datacenter(s). The server 4000 has a system bus 3110, as known in the art, to coordinate and communicate amongst the different components within the server (and by way of known in the art coordination and communication within the datacenter) notably the processor 3100 and its system memory 3021. The server 4000 is operated using an operating system 3022 and onboard controller 3111 to process data the resides in a file system 3023 (typically inclusive of database files) and program data 3025. The server can have an optional display 3113 to convey visual/graphical data to persons interacting with the server, though most often the server's function is to communicate data for visual/graphical representation to a remote computer 4001 (which are known in the art to be inclusive of a wide range devices such as smartphones, pad computers, or other devices capable of providing specific user interaction to any party within the inventive system as a means to encourage transactions that increase the velocity of money through locally sourced products). The server 4000 furthermore runs specific applications that are at a minimum the local currency mining engine 3205, block chain engine 3202, shared resource engine 3204, velocity engine 3201, community impact engine 3203, and community export trade engine 3200.

The remote computer 4001 has identical hardware functionality for identically labeled components of the community server 4000. The community server 4000 and the at least one remote computer 4001 (though it is understood that virtually every person and business place for which transactions are being conducted will have an additional and unique remote computer 4001) communicate through methods known in the art utilizing communication hardware as known in the art inclusive of known wired, and wireless means through their respective network interface 3112. The remote computer 4001, as distinguished from the community server 4000 has the preferential (and optional) addition of augmented and/or virtual reality display 3113.1 for visually/graphically conveying vital impact inclusive of at least the dynamic pricing of the product (or anticipated) in the transaction such that product pricing information is provided in at least the local currency (and preferentially also in the regional currency). It is particularly preferred that the dynamic pricing and the AR/VR display 3113.1 also visually/graphically displays regional and local currency pricing for product alternatives. It is further understood that the personal transaction engine 3211 includes parameters specific to the client indicative of personal preferences as a function of time (e.g., such that a client may prefer to obtain short-term local currency incentives over an otherwise larger long-term currency incentives which can be afforded/invested by the host local community as a direct and indirect result of the communities benefit through enhanced sustainability and internal velocity of money realized through the long-term benefits of compounding).

The below table provides a more detailed functional description of each of the engines:

| Com- | |
|---|---|
| ponent | Function |
| 3205 | Responsible for controlling/coordinating the mining and |
| | issuance of local currency, analogous to known in the art |
| | cryptocurrency or block chain currency, as a function (of |
| | time) with parameters indicative (and encouraging) to a |
| | transition to a sustainable community inclusive of |
| | sustainable businesses, sustainable sourcing of food, |
| | energy, and water, velocity of money within the sustainable |
| | community, and investment in assets that reduce |
| | environmental footprint as well as transactions (external) in |
| | which regional or local currency leaves beyond the geofence |
| | representation of the sustainable community. |
| 3202 | Responsible for controlling authentication, verification, and |
| | audit trail as known in the art such as Bitcoin, Ethereum, |
| | etc. This component is vital to the operation of all digital |
| | currencies, of which this inventive currency is as well. The |
| | execution of transactions is virtually identical of the |
| | inventive local currency in terms of digital currency |
| | management with the fundamental differentiation of being |
| | economically grounded in real sustainable assets and linked |
| | to a pricing system directly linked as a function (of time) to |
| | the benefits and wealth creation within the host community |
| | resulting from the increase in velocity of money. |
| 3204 | Responsible for controlling/managing all aspects of assets |
| | that fall either within a shared use pool or community |
| | owned assets utilized for the public benefit (e.g., bus, train). |
| | The shared resource engine function is inclusive of |
| | scheduling of asset usage, repositioning of asset to |
| | maximize asset utilization in coordination with maximum |
| | system service effectiveness. |
| 3201 | Responsible for controlling/calculating, monitoring, and |
| | projecting the velocity of money as a function of time for |
| | each class/category of assets and transactions. Notably this |
| | component calculates, monitors, and projects the |
| | differential of velocity of money as a function of time |
| | between transaction decisions and options (i.e., choices |
| | between competitive or alternative products, as well as |
| | choices between internally and externally sourced |
| | products/services). |
| 3203 | Responsible for controlling/calculating, monitoring, and |
| | projecting the impact of every transaction (internal and |
| | external) within the host community. It is understood that |
| | host community is relative to and a further function of all |
| | parties to the transaction and their respective community of |
| | residence. |
| 3200 | Responsible for calculating, monitoring, and projecting |
| | trade between multiple communities and specifically for |
| | external projected transactions with the primary controlling |
| | function of dynamically varying product prices to promote |
| | balance of trade and to preferentially encourage the |
| | conduct of transactions using local currency (rather than |
| | regional currency). |
| 3210 | Responsible for calculating and communicating to each |
| | respective engine drawing upon location information for |
| | each party of every transaction for the explicit purpose of |
| | establishing data inclusive of host community (and its |
| | geofence), regional geofence, overlapping geofences (such |
| | as local neighborhood, village or city in which that |
| | neighborhood resides, county in that neighborhood resides, |
| | etc.) |
| 3211 | Responsible for entering all transaction information into |
| | system databases for each personal transaction (and linking |
| | it to the correct residence data object) with comprehensive |
| | recording of parameters ranging from business in which |
| | product was sourced, an at least partial inventory of |
| | components and subcomponents within the product and |
| | the source of those components (and notably the linkage to |
| | the community record in which the task of assembly/service |
| | originated). |

Turning to FIG. 17, FIG. 17 is the data structure centric to the Local Currency Mining Engine 3205. Local currency mining provides for an increase in local digital currency directly accounting for an increasing community 300.1 capacity for self-sustainability, penalty for decreasing such as automating a job particularly one that is for needless consumption especially if it is environmentally harmful, increasing for environmental benefit. Complementary to the issuance of new currency (i.e., mining of currency) is the process of circulating existing previously issued currency such that this local currency (a.k.a. YoCal) provides for earning of currency by way of performing tasks that contribute to the self-sustainability capacity or inventory of produced assets/items/products for local consumption, or increase the use of community shared assets. The fundamental goal of the invention is to provide a YoCal price as compared to the regional currency (i.e., price analogous to the US dollar) through a comparator, such that local purchases are rewarded that have a higher beneficial community impact as directly realized by the shift from non-sustainable business practices to sustainable business practices (which directly realize a reduction in currency outflow away from the host community), and/or by recognizing the direct and subsequent benefits realized by way of velocity of money increases within the host community. Such encouragement is done also in part by way of displaying concentric rings or a pyramid-based structure (or as anticipated to be virtually any graphic to readily indicate the preference of one businesses practices or another) on any on transaction impact on community as a function of business paying living wages, purchasing local content, distributing or reinvesting profits in community, using locally sourced food, energy, water and providing shelter or multi use space. The payment of living wages, yet not also concurrently automating away local jobs that predominantly serve the host community (preferably while accounting for host community unemployment and relative productivity), yet concurrently wanting to encourage net exports by maintaining competitive practices external of the host community.

Multiple financial methods are available within the mechanisms of payment of taxes (or penalties), insurance policies, mortgages, pensions, or leases such that clients are provided incentives of YoCal currency as a function of time over the duration of said financial instruments including the inclusion of earnings by way of effective interest rates. The significant increase of host community wealth due to an increased local velocity of money enables the inventive system where local businesses buy YoCal local currency to offset regional prices such that local banks are able to offer higher savings rates paid in the form of increase YoCal distributions.

Non-sustainable categorized businesses 100.ns include, though not limited to, energy 8501.1 in which fossil fuels are consumed, food 8500.1 in which food is not grown locally and/or creates an adverse fertilizer impact on soils or water, water 8502.1 in which traditional high evaporation method are deployed or low water recovery/recycle is realized, shelter 8503.1 in which no public benefit is realized and/or low income housing is provided, data center 8503.1 in which the location is external of the host community 300.1 and fails to utilize community 300.1 renewable energy sources as its power source, financial 8504.1 which conducts financial service transactions whereby the respective business doesn't maintain a minimum reinvestment of profits into the host community 300.1, and non-shared resource 810.ns businesses in which single-client transactions are conducted. Sustainable businesses 100.s are generally characterized by practices that are resource sustainable at large, and more specifically and preferred practices in which a minimum threshold (of at least 51%, preferably at least 70%, and specifically preferred at least 90%) is achieved within the geofence of the host community 300.1 as calculated by the community impact engine 3203. Sustainable businesses include biomass conversion to fuel 1130 production processes, biomass conversion to electricity 1140 production processes, biomass grower(s) 1100, CO2 sequestration 1141 production processes which at least temporarily sequester CO2 (and preferably permanently), food grower 8501.s production within the host community 300.1, renewable energy producer 8501.s preferably within the host community 300.1, and shared resource 810.s preferably within the host community 300.1 of assets owned by the same community (but at a minimum reducing the communities currency outflow by way of discouraging asset acquisition with low utilization rates). The community impact engine 3203 calculates both the absolute transaction impact on the host community 300.1 and the relative impact of all transaction available options notably internal 510.1 vs. external 510.2 transactions. It is anticipated that internal 510.1 transactions may include the issuance of newly mined YoCal currency in addition to the more frequent trading of YoCal currency as a function of time.

The local currency mining engine 3205 controls the issuance of YoCal currency as a function of time (meaning the mining of currency is not solely for instantaneous circulation into the economy but rather often for future issuance) as calculated for the internal transaction 510.1 and alternatively for penalty for the external transaction 510.2. The local currency mining engine 3205 is also a function of shared resource 810 in which a specific asset 850.1 is part of the transaction (and more particularly is further impacted by the ownership of the asset). The engine 3205 is also a function of the payment of living wages as compared to the living wage standard 217 for the host community 300.1 through analysis of wage record(s) 216 within the community at large and also notably for the business conducting the transaction. A comparative analysis is also calculated to address the community impact between non-sustainable task(s) 2250.ns and sustainable task(s) 2250.s in which exemplary tasks include tasks in which aggregation into a group provides for efficiency gains as compared to the summation of individual tasks (e.g., shopping, baking, slicing, laundry) or swapped hosting tasks (e.g., restaurant, cleaning of common areas) or tasks within shared service (e.g., driving, laundry, etc.). The local currency mining engine 3205 controls the issuance of currency as a function of (velocity of money, time, and at least one of the following: 1) conversion of a non-sustainable business/process to a sustainable one, 2) conversion of a non-shared to a shared transaction, 3) conversion of an external to an internal transaction, 4) participation in a task swap exchanger, 5) conversion from a sub-living wage to an at least living wage, 6) community volunteering to accelerate the conversions of #1-#5 faster, 7) efficiency gains realized/projected to reduce Asset requirements in the transition from a non-sustainable to a sustainable business having a same/similar function (e.g., food production, energy production, etc.).

Turning to FIG. 18, FIG. 18 incorporates a fundamental element in the inventive system is a rating scale for all parties of the transaction (e.g., business, client, employee) to incentivize every party to increase local content and enhanced sustainability within the host community in which the transaction is taking place. The Rating Scale has at least three rating portions (here depicted as an interior concentric circle 7770.1, a middle concentric circle 7770.2, and an external concentric circle 7770.3). It is understood that additional (or less) rating portions can be shown as well as the shape can be any reasonable shape notably a pyramid. One representative meaning for each rating portion has a different meaning for a Residence 310, a Client 400 (who could also be a Residence), an Employee 215 (who could also be a Residence) of a respective Business 100 within the Community 300.1. The representative meanings are depicted in the below table:

| Indicator | Residence | Client | Employee | Business |
|---|---|---|---|---|
| Interior | Use of Shared | Purchase of | Purchase of | Purchase of |
| | Resources | Locally Sourced | Locally Sourced | Locally Sourced |
| | | Goods | Goods | Goods |
| Middle | Volunteer or | Use of Shared | Use of Shared | Hiring |
| | Employee | Vehicle to | Vehicle to | Employees |
| | Contributing to | Conduct this | Commute to | Living in |
| | Community | Transaction | Business (where | Community |
| | | | employed) | |
| Exterior | Use of | Shops at | Shops at | Reinvestment of |
| | Community | Businesses that | Businesses that | Profits into |
| | Financial Entities | Locally Source | Locally Source | Community |
| | | Goods | Goods | |

The representative ratings are preferably integrated as a function of (Velocity of Money and Community Impact) and ultimately indicative of commitment towards increasing sustainability of host Community 300.1 which also includes establishing specific communities in which a balance of trade partnership is created. The preferred trade partnership places a weighting factor that favors partnerships in which living wages are paid (especially for items in which the partnerships trade in).

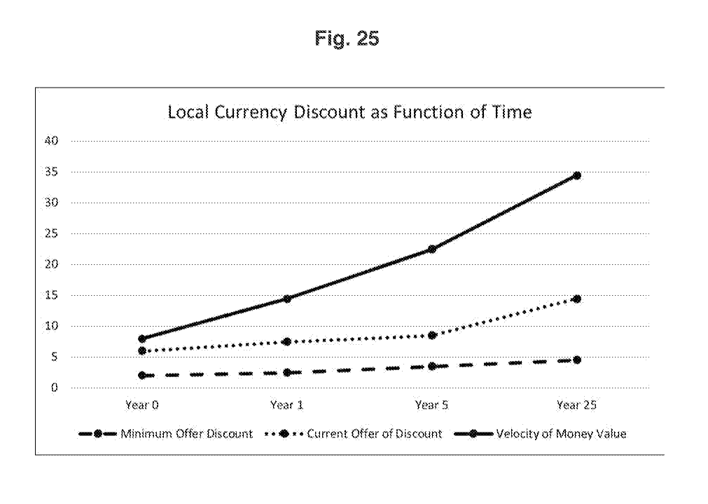

Turning to FIG. 19, FIG. 19 depicts the data structure as calculated, communicated, and then presented to client 400 to show regional and local pricing in their respective currency for the product being considered in the transaction and at least one alternative, competitive product with the intent of promoting transaction decisions that maximize local content and sustainability within the host community. It is understood that each respective engine (as shown in FIG. 16) is: a) specific to each client notably around the residence community of that client which is not inherently the same as the host community 300.1 in which the business is being transacted in, b) is a function of each product having a business 100.1 where the product is sourced, the purchase of that product (if not manufactured by that business 100.1) as recorded by purchase record 220.1, which has components or sub-components from their respective source 225.1. This aforementioned product (0.1) is compared through the comparator control function (which can be a singular price at time=0 i.e., the time of the transaction, or preferably as a function (of time) where the transaction is compared between an at least one second product represented by business 100.2, purchase 220.2, and source 225.2 records. It is understood that the invention anticipates tabular or graphic depictions of pricing as a function of time such as shown in the below FIG. 25.

FIG. 25 depicts one graphical representation of calculated data for a product pricing, where the Velocity of Money Value shows the actual projected full gains realized by the purchase of the respective product when maximizing velocity of money and/or sustainability relative to the nearest optional product alternative. It is understood that the inventive system doesn't need to (and in fact should not) provide the client with the full realized community value but rather a calculated Current Offer of Discount to incentivize the client to make a purchase of the product that yields gain to the host community (i.e., an effective provision of local currency to offset an otherwise product pricing that has a lower regional currency price). The Minimum Offer Discount is the calculated level of community wealth creation minimum potential sharing with the client. The velocity engine 3201, community impact engine 3203, and community export trade engine 3200 (not depicted in this figure, but rather FIG. 16) utilize data as stored in a historic database of virtually all “interim” offers made to the specific Client (which is also used for comparison to additional clients for predictive purposes optimally selected by pattern matching and/or artificial intelligence) for a real-time creation of Current Offer of Discount so as to maximize long-term host community wealth and ensuring direct benefits to the client as a result of providing direct and indirect consideration of the host community despite otherwise alternative/competitive products having a lower regional currency pricing.

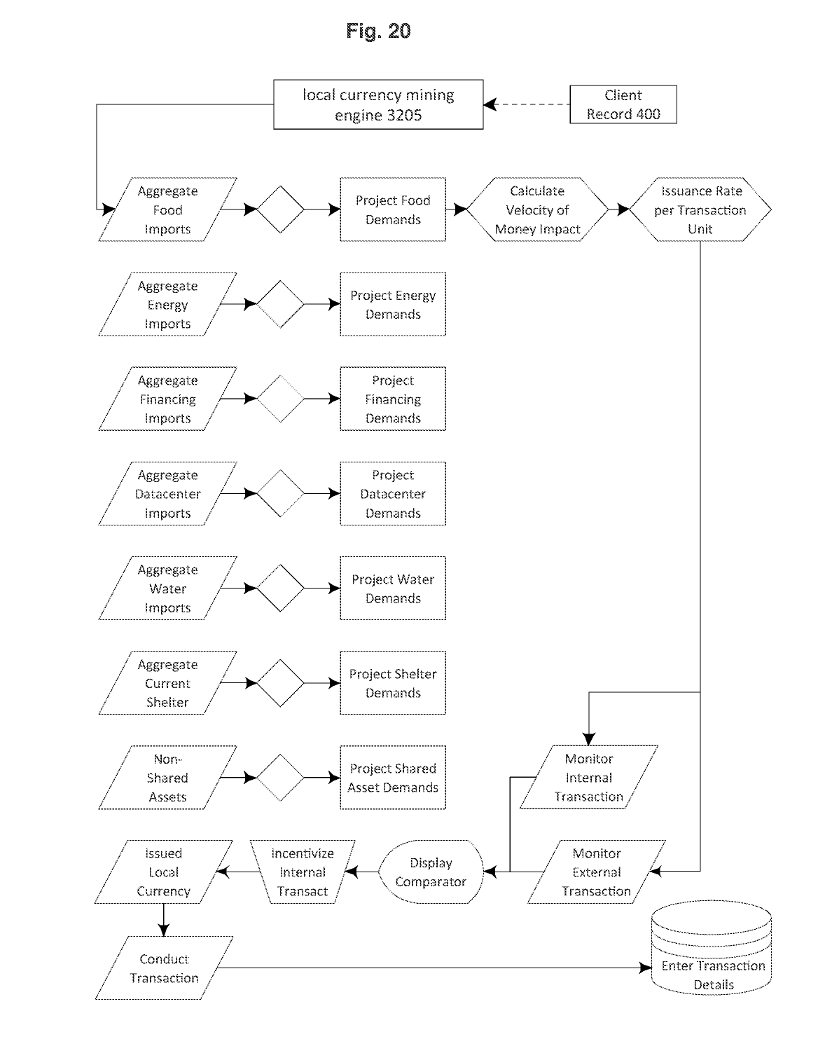

Turning to FIG. 20, FIG. 20 depicts operational control of the local currency mining engine 3205 as a specific application program on the server. Each control operation is a direct function to a specific client 400. Each type of aggregation is virtually identical for each aggregate type though only shown completely for aggregate food imports in which the system calculates the aggregate of food imports (within at least one community, though preferably for the series of nested and overlapping community geofences), then makes decisions as a function of the application programming and program data in conjunction with records in the database so as to enable a calculation of projected food demands also within at least one community, though preferably for the series of nested and overlapping community geofences. The system then calculates the velocity of money impact for each community geofence in order to control as a function of time an issuance rate per food transaction unit, then analyze the rate for both of a monitored (which is pending/potential) internal transaction along with corresponding potential external transaction (or vice versa). The system then creates a comparison table/graphic through the display comparator function in addition to calculating and controlling an incentivizing data structure in order to promote an internal transaction (that will maximize community and client wealth) through the issuance (i.e., mining) or trading of YoCal local currency. Finally, the system conducts the transaction and enters into the transaction database the fundamental parameters for the successfully completed transaction, each offered (though not taken) internal and external transaction, and all artificial intelligence or neural network or vector pattern recognition methods so as to reduce the iterations between non-successful incentivizing offers and the successfully conducted transaction in the future. This system process is available for each of the exemplary product categories including energy, financing, datacenter, water, current shelter, and non-shared assets.

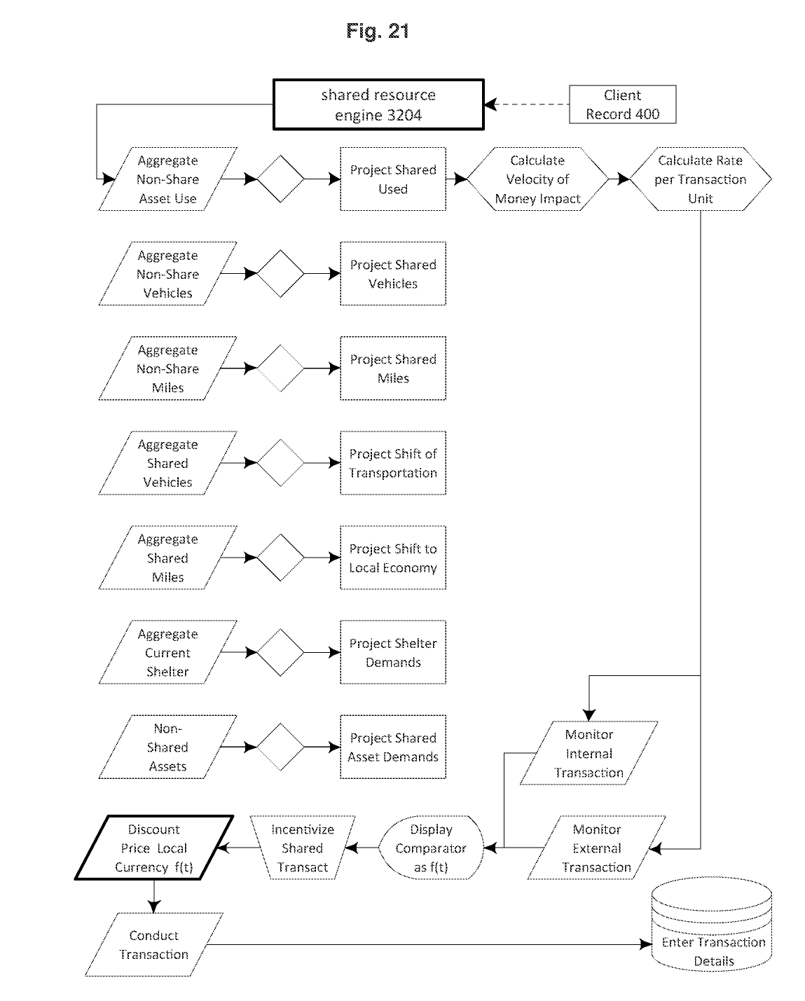

Turning to FIG. 21, FIG. 21 goes through the identical process of FIG. 20 yet is for the shared resource engine 3204 application. The exemplary asset type in this figure (analogous to food in FIG. 20) is for the general category of non-shared assets used in the community. The objective of this application program within the system is to maximize the use of assets within a shared resource pool with the explicit objective of increasing asset utilization factor and minimizing non-shared assets (which virtually always leads to the individual ownership of a large quantity lowly utilized assets).

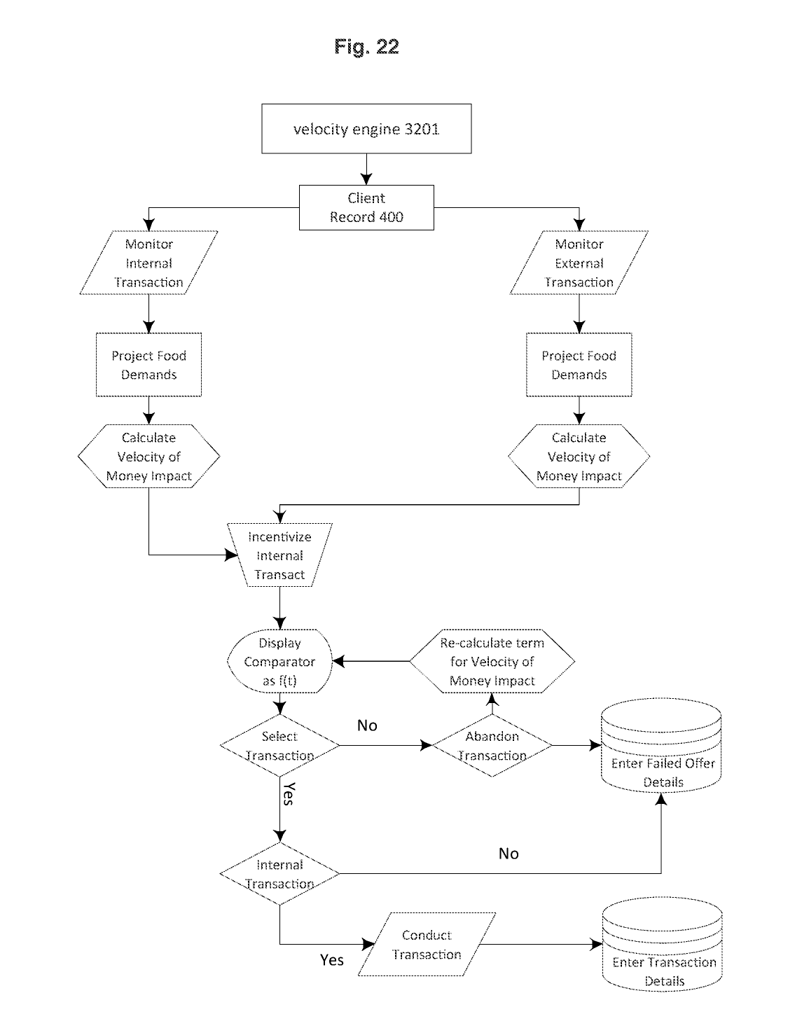

Turning to FIG. 22, FIG. 22 is the system operating program for the velocity engine 3201 that is specific to a unique client 400. The client provides a preliminary indication of either an internal or external transaction, leading to the system monitoring, calculating, and then displaying comparative external or internal transaction(s). The system calculates projected demand for both internal and external transactions based on the product category (in this figure indicated for food products), then calculates the velocity of money impact (on the community) for both potential/pending transactions. This figure is very similar to FIGS. 20 and 21, though with further clarity of the iterative process when a specific transaction is not selected leading to either abandonment of any transaction or recalculation of terms for the velocity of money impact therefore leading to modifications and recalculation of a proposed transaction. All iterative offers are stored in a database, as well as accepted offers leading to successful transactions.

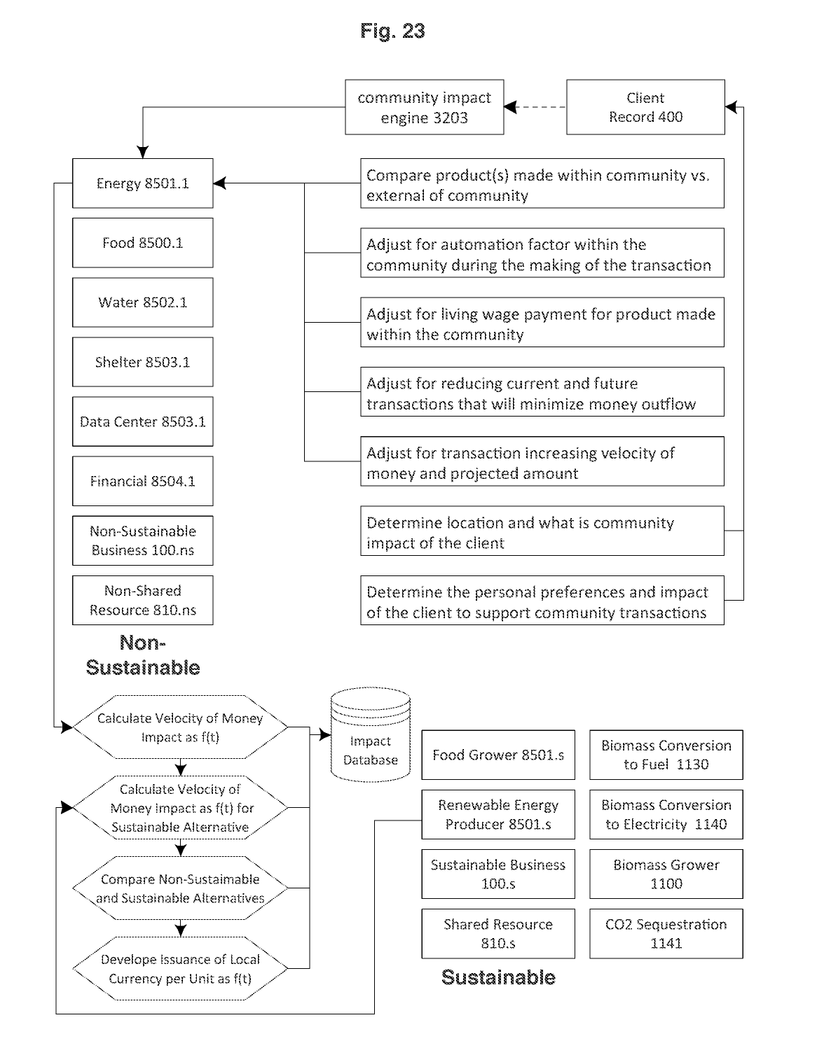

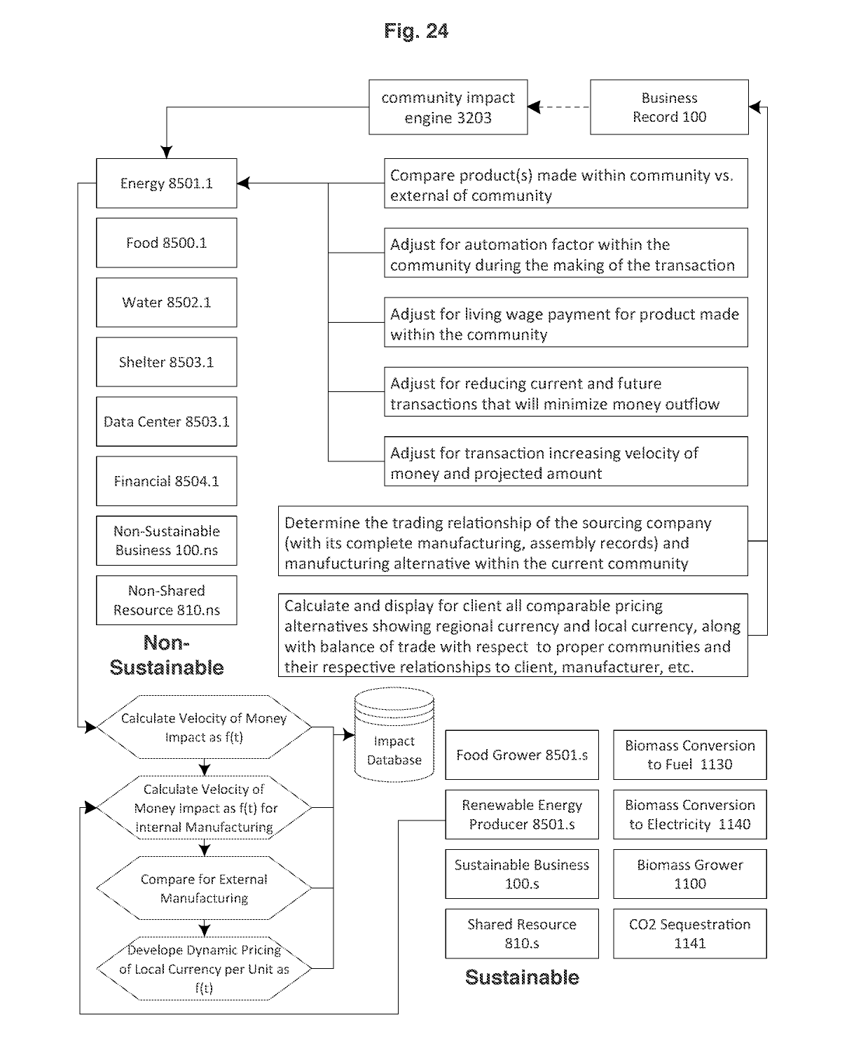

Turning to FIG. 23, FIG. 23 is the process diagram centered around the community impact engine 3203. The illustrative process in this instance, though understood that each other business category (e.g., food, water, shelter, data center, financial, generally non-sustainable business and non-shared resource businesses) also goes through an identical process. The community impact engine calculates all parameters taking into account a specific client 400 with its respective personal profile, data, historic preferences, and comparative profiles for pattern recognition matched other personal profiles. The process of the community impact engine includes first the calculation of the client 400 location so as to establish at least one community in which the client is related to including: a) the present location of the client in which the transaction is taking place, b) the overlapping geofence communities (e.g., county, state, country), c) community of client residence. Once the community geofence(s) are established the role of the community impact engine 3203 is to determine comparative transactions (which can be alternative, substitute, or competitive) and their respective and relative impact on the community by calculating the velocity of money impact as a function of time “f(t)”. The impact is first calculated velocity of money impact as f(t) for sustainable alternative(s) and then a comparative analysis is conducted between the non-sustainable and sustainable alternative(s) as continuously updated in the impact database (which is for each individual community, as well as a comprehensive database of comparative and reference community models). Renewable energy producer(s) within the community (as a recognized sustainable business) or accessible to community consumers provide critical parameters to be included in the velocity of money impact. Additional critical parameters are included in the velocity of money impact calculations (e.g., food grower, biomass conversion to fuel, biomass conversion to electricity, sustainable business, biomass grower, shared resource, and carbon dioxide “CO2” sequestration assets). The end result of this process is the development of a issuance of local currency per unit (i.e., of transaction) as a function of time f(t) to at the least encourage an increase in velocity of money impact on the community and preferably to optimize/maximize the increase in velocity of money as f(t). The community impact engine 3203 repeats this process for each relevant comparative analysis. In virtually all instances the following are critical parameters in establishing a comparative community impact: a) compare product(s) made within the community vs. product(s) made external of the community (which includes competitive, substitute, or alternative products), b) adjustment for automation factor(s) within the community during the making of the transaction (which includes primary impact of automation, as well as secondary impact of automation such as enhanced productivity to increase exports outside of the community for future transactions), c) adjustment for living wage payment(s) for product(s) made within the community, d) adjustment for reducing current and future transactions that will minimize money outflow(s), and e) adjustment for transaction increasing velocity of money and projected amount.

Turning to FIG. 24, FIG. 24 is the process diagram centered around the community impact engine 3203 but rather than client centric as in FIG. 23 this is business 100 centric. This figure is virtually identical as FIG. 23 except for post-calculation of the velocity of money impact as f(t) for sustainable alternatives, the process calculates the velocity of money impact as f(t) for internal manufacturing in order to calculate the comparative impact on the community of this transaction between internal and external transactions (such as substitute, competitive, and alternative products). The result of this process comparison, is the community impact engine 3203 develops a dynamic pricing model in local currency per unit (of the transaction) as a f(t). Prior to this dynamic pricing model being calculated and then issued and displayed to the client to influence their decision-making process at least a representative comparison table/graphic between the various alternatives including the various currency (local, regional) along with the balance of trade with respect to proper communities and their respective relationships to client, product manufacture, etc. The impact engine also determines the multi-parametric analysis of the sourcing company (for the transaction) with its complete manufacturing, assembly record(s) and manufacturing alternative(s) within the current host community of the transaction.

Although the invention has been described in detail, regarding certain embodiments detailed herein, other anticipated embodiments can achieve the same results. Variations and modifications of the present invention will be obvious to those skilled in the art and the present invention is intended to cover in the appended claims all such modifications and equivalents.

What is claimed is:

1. A transaction system that issues a local currency used in building a transaction occurring on a transaction day, comprising: at least one computing device wherein the at least one computing device interacts with a dynamic pricing engine whereby the dynamic pricing engine stores and executes program instructions executable in the at least one computing device, the dynamic pricing engine comprising: logic that prices the transaction based on a first currency and a second currency having associated therewith a pricing mechanism, the pricing mechanism being configured to establish a transaction price in the first currency whereby the first currency is a regional currency and whereby the second currency is a local currency; logic that determines whether a plurality of parameters and conditions associated with the second currency are fulfilled including a community established as a local community by an at least one of a business or a client community wherein the transaction is executed; and logic derived by the program instructions that builds the transaction at a price having both the first currency and the second currency whereby the second currency is based on a transaction community impact within the at least one of a business or a client community using the dynamic pricing engine further comprised of a controller in communication with an at least one database, a memory coupled to the controller configured to store program instructions executable by the controller wherein the controller selects an at least one database record from the at least one database to calculate and project the transaction community impact within the at least one of the business or the client community.

2. The transaction system according to claim 1, wherein the transaction comprises a purchase of a product or a service, or the execution of a task.

3. The transaction system according to claim 1, wherein the second currency is a crypto or blockchain currency wherein the second currency has a value directly correlated to a community impact value increase for at least one day beyond the transaction day.

4. The transaction system according to claim 1, wherein the second currency is a variable pricing process establishing the transaction price by a plurality of parameters including a velocity of money parameter of the local community to result in the transaction community impact being increased within the local community of the client.

5. The transaction system according to claim 1, wherein the second currency is a variable pricing process establishing the transaction price by a plurality of parameters including a historic parameter based on the transaction community impact being increased within the local community of the business.

6. The transaction system according to claim 1, wherein the second currency is a variable pricing process establishing the transaction price by a plurality of parameters including a historic parameter based on a local value community impact of the client from the at least one of the business or the client within the local community.

7. The transaction system according to claim 1 whereby the dynamic pricing engine has a program that comprises a programming code to price a product or a service based on a parameter from a plurality of parameters associated with the second currency including a local community impact on logistics on a good or service in the transaction.

8. The transaction system according to claim 1 whereby the dynamic pricing engine has a program that comprises a programming code to price a product or a service based on a parameter from a plurality of parameters associated with the second currency including a local community impact on a manufacturing of a good or service in the transaction.

9. The transaction system according to claim 1 whereby the dynamic pricing engine has a program that comprises a programming code to price a product or a service based on a parameter from a plurality of parameters associated with the second currency including a local community impact on a currency outflow from the local community in the transaction operable to minimize the currency outflow.

10. The transaction system according to claim 1 whereby the dynamic pricing engine has a program that comprises a programming code to price a product or a service based on a parameter from a plurality of parameters associated with the second currency including a local community impact on a currency inflow from the local community in the transaction operable to maximize the currency inflow.

11. The transaction system according to claim 1 whereby the dynamic pricing engine has a program that comprises a programming code to price a product or a service based on a parameter from a plurality of parameters associated with the second currency including a local community impact on a universal basic income from the local community in the transaction operable to minimize a burden on the local community.

12. The transaction system according to claim 1 whereby the dynamic pricing engine has a program that comprises a programming code to price a product or a service based on a parameter from a plurality of parameters associated with the second currency including a local community impact relative to an at least one alternative or substitute product or service.

13. The transaction system according to claim 1 whereby the dynamic pricing engine has a program that comprises a programming code to price a product or a service based on a parameter from a plurality of parameters associated with the second currency including a local reinvestment of profits gained by the business in the transaction.

14. The transaction system according to claim 1 whereby the dynamic pricing engine has a program that comprises a programming code to price a product or a service based on a parameter from a plurality of parameters associated with the second currency including a local community impact of an asset within a shared resource pool within the local community.

15. The transaction system according to claim 1 whereby the dynamic pricing engine has a program that comprises a programming code to price a product or a service based on a parameter from a plurality of parameters associated with the second currency including an employee of the business in the transaction and an at least one parameter associated with a transportation asset used by an employee having an employee residence whereby the employee residence is identical to the local community of the business of the transaction.

16. The transaction system according to claim 1 whereby the dynamic pricing engine for the transaction compares a local community impact differential between a good or service of the transaction on a sustainable or a non-sustainable process.

17. The transaction system according to claim 1 whereby the dynamic pricing engine for the transaction compares a local community impact differential between a good or service of the transaction on a shared resource or a non-shared resource process.

18. The transaction system according to claim 1 whereby the dynamic pricing engine for the transaction compares a local community impact differential between a good or service of the transaction on a living wage or a non-living wage process.

19. The transaction system according to claim 1 further comprised of a local currency mining engine whereby the local currency mining engine issues additional local currency as a function of the local community velocity of money over time.

20. The transaction system according to claim 1 further comprised of a local currency mining engine whereby the local currency mining engine issues additional local currency as a function of the local community balance of trade with a second community and a differential of a local community velocity of money over time and the second community.
